(19) United States
(12) Patent Application Publication
(10) Pub. No.: US 2026/0194705 A1
(43) Pub. Date: Jul. 9, 2026

(54) HOLLOW-CORE FIBERS FEATURING ANTI-RESONANT ELEMENTS WITH ENGINEERED NODE THICKNESS

(71) Applicant: Relativity Networks, Inc., Winter Park, FL (US)

(72) Inventors: Jason M. EICHENHOLZ, Orlando, FL (US); Md Selim HABIB, West Melbourne, FL (US); Rodrigo AMEZCUA CORREA, Orlando, FL (US); Jose Enrique ANTONIO-LOPEZ, Orlando, FL (US)

(21) Appl. No.: 19/439,836

(22) Filed: Jan. 5, 2026

Related U.S. Application Data
(60) Provisional application No. 63/743,520, filed on Jan. 9, 2025.
(60) Provisional application No. 63/786,289, filed on Apr. 10, 2025.
(60) Provisional application No. 63/829,472, filed on Jun. 24, 2025.
(60) Provisional application No. 63/829,483, filed on Jun. 24, 2025.
(60) Provisional application No. 63/829,489, filed on Jun. 24, 2025.
(60) Provisional application No. 63/831,544, filed on Jun. 27, 2025.
(60) Provisional application No. 63/859,019, filed on Aug. 6, 2025.
(60) Provisional application No. 63/881,331, filed on Sep. 13, 2025.
(60) Provisional application No. 63/885,111, filed on Sep. 19, 2025.
(60) Provisional application No. 63/888,648, filed on Sep. 26, 2025.
(60) Provisional application No. 63/897,460, filed on Oct. 10, 2025.
(60) Provisional application No. 63/897,545, filed on Oct. 10, 2025.
(60) Provisional application No. 63/897,615, filed on Oct. 11, 2025.
(60) Provisional application No. 63/908,278, filed on Oct. 30, 2025.
(60) Provisional application No. 63/913,432, filed on Nov. 7, 2025.

(51) Int. Cl. G02B 6/02; C03B 37/027

(52) U.S. Cl. CPC G02B 6/02338; G02B 6/02328; C03B 37/02781; C03B 2203/16

(57) ABSTRACT

An optical fiber including a cladding structure, a first anti-resonant (AR) element and a second AR element is disclosed. The cladding structure extends along a fiber length providing a hollow interior fiber region. The first and second AR elements are distributed within the hollow interior fiber region. The first AR element and the second AR element are formed as walled structures with one or more walls extending along the fiber length. Further, the first AR element and the second AR element touch each other at an intersection wall portion, and the intersection wall portion is engineered to have an engineered thickness.

### CROSS-REFERENCE TO RELATED APPLICATIONS

The present application claims the benefit of U.S. Provisional Patent Applications 63/829472 filed on Jun. 24, 2025; 63/743520 filed on Jan. 9, 2025; 63/786289 filed on Apr. 10, 2025; 63/908278 filed on Oct. 30, 2025; 63/829483 filed on Jun. 24, 2025; 63/829489 filed on Jun. 24, 2025; 63/831544 filed on Jun. 27, 2025; 63/859019 filed on Aug. 6, 2025; 63/881331 filed on Sep. 13, 2025; 63/885111 filed on Sep. 19, 2025; 63/888648 filed on Sep. 26, 2025; 63/897460 filed Oct. 10, 2025; 63/897615 filed on Oct. 11, 2025; 63/897545 filed on Oct. 10, 2025; and 63/913432 filed on Nov. 7, 2025. All of the above provisional patent applications are hereby incorporated herein by reference in their entirety.

### TECHNICAL FIELD

The present disclosure relates generally to hollow core optical fibers, and more specifically to hollow core optical fibers having anti-resonant elements with engineered node thickness.

### BACKGROUND OF THE INVENTION

As the demand for data communication services, Internet, cloud computing, information exchange, etc. has exponentially increased over the past few decades, newer telecom infrastructure is being developed that offers higher transmission capacity, lower loss and lower latency. An example of such a telecom infrastructure includes anti-resonant (AR) hollow-core fibers (HCFs). An AR-HCF offers various benefits over a traditional glass or solid core optical fiber (SMF/MMF) including, but not limited to, a high average and peak power capability, high damage thresholds, low latency, low non-linearities, etc.

An AR-HCF typically includes one or more tubular elements (or “AR elements”) and/or structures having thin walls (thin meaning smaller length thickness when compared to the wavelength of the propagating light within the fiber), which enables light to propagate through the elements without significant losses. As newer structures of AR-HCFs are being developed, there is a need to ensure that the optical anti-resonance properties of the AR elements are not negatively impacted in the new fiber designs.

### BRIEF DESCRIPTION OF THE DRAWINGS

Various embodiments of the invention are disclosed in the following detailed description and the accompanying drawings.

FIG. 1A depicts a cross-sectional view of a first embodiment of an anti-resonant (AR) hollow-core fiber (HCF), in accordance with one or more embodiments of the present disclosure.

FIG. 1B depicts a cross-sectional view of a second embodiment of an AR-HCF, in accordance with one or more embodiments of the present disclosure.

FIG. 1C depicts a cross-sectional view of a third embodiment of an AR-HCF, in accordance with one or more embodiments of the present disclosure.

FIG. 1D depicts a cross-sectional view of a fourth embodiment of an AR-HCF, in accordance with one or more embodiments of the present disclosure.

FIG. 1E depicts a cross-sectional view of a fifth embodiment of an AR-HCF, in accordance with one or more embodiments of the present disclosure.

FIG. 1F depicts a cross-sectional view of a sixth embodiment of an AR-HCF, in accordance with one or more embodiments of the present disclosure.

FIG. 1G depicts a cross-sectional view of a seventh embodiment of an AR-HCF, in accordance with one or more embodiments of the present disclosure.

FIG. 1H depicts a cross-sectional view of an eighth embodiment of an AR-HCF, in accordance with one or more embodiments of the present disclosure.

FIG. 1J depicts a cross-sectional view of a ninth embodiment of an AR-HCF, in accordance with one or more embodiments of the present disclosure.

FIG. 1K depicts a cross-sectional view of a tenth embodiment of an AR-HCF, in accordance with one or more embodiments of the present disclosure.

FIG. 1L depicts a cross-sectional view of an eleventh embodiment of an AR-HCF, in accordance with one or more embodiments of the present disclosure.

FIG. 2A depicts a cross-sectional view of a twelfth embodiment of an AR-HCF, in accordance with one or more embodiments of the present disclosure.

FIG. 2B depicts a cross-sectional view of a thirteenth embodiment of an AR-HCF, in accordance with one or more embodiments of the present disclosure.

FIG. 2C depicts a cross-sectional view of a fourteenth embodiment of an AR-HCF, in accordance with one or more embodiments of the present disclosure.

FIG. 2D depicts a cross-sectional view of a fifteenth embodiment of an AR-HCF, in accordance with one or more embodiments of the present disclosure.

FIG. 2E depicts a cross-sectional view of a sixteenth embodiment of an AR-HCF, in accordance with one or more embodiments of the present disclosure.

FIG. 2F depicts a cross-sectional view of a seventeenth embodiment of an AR-HCF, in accordance with one or more embodiments of the present disclosure.

FIG. 2G depicts a cross-sectional view of an eighteenth embodiment of an AR-HCF, in accordance with one or more embodiments of the present disclosure.

FIG. 2H depicts a cross-sectional view of a nineteenth embodiment of an AR-HCF, in accordance with one or more embodiments of the present disclosure.

FIG. 3A depicts a cross-sectional view of a twentieth embodiment of an AR-HCF, in accordance with one or more embodiments of the present disclosure.

FIG. 3B depicts a cross-sectional view of a twenty-first embodiment of an AR-HCF, in accordance with one or more embodiments of the present disclosure.

FIG. 3C depicts a cross-sectional view of a twenty-second embodiment of an AR-HCF, in accordance with one or more embodiments of the present disclosure.

FIG. 3D depicts a cross-sectional view of a twenty-third embodiment of an AR-HCF, in accordance with one or more embodiments of the present disclosure.

FIG. 4A depicts a cross-sectional view of a twenty-fourth embodiment of an AR-HCF, in accordance with one or more embodiments of the present disclosure.

FIG. 4B depicts a cross-sectional view of a twenty-fifth embodiment of an AR-HCF, in accordance with one or more embodiments of the present disclosure.

FIG. 5A depicts a cross-sectional view of a twenty-sixth embodiment of an AR-HCF, in accordance with one or more embodiments of the present disclosure.

FIG. 5B depicts a cross-sectional view of a twenty-seventh embodiment of an AR-HCF, in accordance with one or more embodiments of the present disclosure.

FIG. 5C depicts a cross-sectional view of a twenty-eighth embodiment of an AR-HCF, in accordance with one or more embodiments of the present disclosure.

FIG. 5D depicts a cross-sectional view of a twenty-ninth embodiment of an AR-HCF, in accordance with one or more embodiments of the present disclosure.

FIG. 6A depicts a cross-sectional view of a thirtieth embodiment of an AR-HCF, in accordance with one or more embodiments of the present disclosure.

FIG. 6B depicts a cross-sectional view of a thirty-first embodiment of an AR-HCF, in accordance with one or more embodiments of the present disclosure.

FIG. 6C depicts a cross-sectional view of a thirty-second embodiment of an AR-HCF, in accordance with one or more embodiments of the present disclosure.

FIG. 6D depicts a cross-sectional view of a thirty-third embodiment of an AR-HCF, in accordance with one or more embodiments of the present disclosure.

FIG. 6E depicts a cross-sectional view of a thirty-fourth embodiment of an AR-HCF, in accordance with one or more embodiments of the present disclosure.

FIG. 7 depicts a cross-sectional view of a thirty-fifth embodiment of an AR-HCF, in accordance with one or more embodiments of the present disclosure.

FIG. 8 depicts a cross-sectional view of a thirty-sixth embodiment of an AR-HCF, in accordance with one or more embodiments of the present disclosure.

FIG. 9 is a flow diagram of a method to make an AR-HCF in accordance with one or more embodiments of the present disclosure.

FIG. 10 depicts a cross-sectional view of a thirty-seventh embodiment of an AR-HCF, in accordance with one or more embodiments of the present disclosure.

FIG. 11 depicts graphs between fundamental mode losses and wavelengths for different thicknesses of walls of AR elements of the AR-HCF of FIG. 10 for a first type of engineered node, in accordance with one or more embodiments of the present disclosure.

FIG. 12 depicts graphs between fundamental mode losses and wavelengths for different thicknesses of walls of AR elements of the AR-HCF of FIG. 10 for a second type of engineered node, in accordance with one or more embodiments of the present disclosure.

FIG. 13 depicts graphs between fundamental mode losses and wavelengths for different thicknesses of walls of AR elements of the AR-HCF of FIG. 10 for a third type of engineered node, in accordance with one or more embodiments of the present disclosure.

FIG. 14 depicts graphs between fundamental mode losses and wavelengths for different thicknesses of walls of AR elements of the AR-HCF of FIG. 10 for a fourth type of engineered node, in accordance with one or more embodiments of the present disclosure.

FIG. 15 depicts graphs between fundamental mode losses and wavelengths for a predetermined thickness of walls of AR elements of the AR-HCF of FIG. 10 for different types of engineered nodes, in accordance with one or more embodiments of the present disclosure.

FIG. 16 depicts a graph between higher order mode losses and wavelengths for a predetermined thickness of walls of AR elements of the AR-HCF of FIG. 10 for different types of engineered nodes, in accordance with one or more embodiments of the present disclosure.

FIG. 17 depicts a graph between fundamental mode losses and bend radius of AR-HCF for a predetermined thickness of walls of AR elements of the AR-HCF of FIG. 10 for different types of engineered nodes, in accordance with one or more embodiments of the present disclosure.

FIG. 18 depicts a graph between fundamental mode losses and wavelengths for different thicknesses of “doped” walls of AR elements of the AR-HCF of FIG. 10 for the first type of engineered node, in accordance with one or more embodiments of the present disclosure.

FIG. 19 depicts a graph between fundamental mode losses and wavelengths for different thicknesses of “doped” walls of AR elements of the AR-HCF of FIG. 10 for the second type of engineered node, in accordance with one or more embodiments of the present disclosure.

FIG. 20 depicts a graph between fundamental mode losses and wavelengths for different thicknesses of “doped” walls of AR elements of the AR-HCF of FIG. 10 for the fourth type of engineered node, in accordance with one or more embodiments of the present disclosure.

FIG. 21 depicts a cross-sectional view of a thirty-eighth embodiment of an AR-HCF, in accordance with one or more embodiments of the present disclosure.

FIG. 22 depicts a graph between fundamental mode losses and wavelengths for a predetermined thickness of walls of AR elements of the AR-HCF of FIG. 21 for different types of engineered nodes, in accordance with one or more embodiments of the present disclosure.

FIG. 23 depicts a graph between dispersion and wavelengths for a predetermined thickness of walls of AR elements of the AR-HCF of FIG. 21 for a predetermined type of engineered node, in accordance with one or more embodiments of the present disclosure.

FIG. 24 depicts graphs between fundamental mode and higher order mode losses and wavelengths for a predetermined thickness of walls of AR elements of the AR-HCF of FIG. 21 for a predetermined type of engineered node, in accordance with one or more embodiments of the present disclosure.

FIG. 25 depicts graphs between fundamental mode losses and wavelengths for a predetermined thickness of walls of AR elements of the AR-HCFs of FIGS. 10 and 21 for a predetermined type of engineered node, in accordance with one or more embodiments of the present disclosure.

FIG. 26 depicts a cross-sectional view of a thirty-ninth embodiment of an AR-HCF and a graph between fundamental mode losses and wavelengths for a predetermined thickness of walls of AR elements of the thirty-ninth embodiment of AR-HCF for a predetermined type of engineered node, in accordance with one or more embodiments of the present disclosure.

### SUMMARY

An optical fiber is disclosed in accordance with one or more illustrative embodiments. In some embodiments, the optical fiber may include a cladding structure extending along a fiber length providing a hollow interior fiber region. The optical fiber may further include a first anti-resonant (AR) element and a second AR element distributed within the hollow interior fiber region. The first AR element and the second AR element may be formed as walled structures with one or more walls extending along the fiber length. Further, the first AR element and the second AR element may touch each other at a first intersection wall portion or a contact region, and the first intersection wall portion/contact region may be engineered (e.g., thinned by etching or via mechanical thinning or laser processing or other applicable method) to have a first engineered thickness.

In certain embodiments, the one or more walls of the first AR element may have a first thickness and the one or more walls of the second AR element may have a second thickness. The first engineered thickness may be less than a sum of the first thickness and the second thickness.

In some embodiments, the first thickness may be equivalent to the second thickness. In this case, the first engineered thickness may be equivalent to the first thickness or the second thickness.

The first intersection wall portion/contact region may be engineered by using one or more of: dry etching, wet etching, laser processing, mechanical processing, Reactive Ion Etching (RIE), Deep Reactive Ion Etching (DRIE), sputter etching, ion beam etching (IBE), vapor phase etching, or other applicable process. The shape of the drawn fiber structure may be different than the shape of the preform and can be tailored based on fiber-draw paraments, such as draw speed, draw tension, surface tension, draw ratio, temperature, AR-element material, and differential pressures.

Furthermore, in some embodiments, the first AR element and the second AR element may be positioned on an interior surface of the cladding structure. In certain embodiments, a width or diameter of the first AR element may be equivalent to a width or diameter of the second AR element. In other embodiments, the width or diameter of the first AR element may be different from the width or diameter of the second AR element.

In some embodiments, the optical fiber may further include a third AR element and/or a fourth AR element located within an interior region of the first AR element bounded at least in part by the walls or support structure of the first AR element. In certain embodiments, the third AR element and/or the fourth AR element may be positioned on the interior surface of the cladding structure. In other embodiments, the third AR element and/or the fourth AR element may be positioned on the walls or support structure of the first AR element and not on the interior surface of the cladding structure.

In some embodiments, the third AR element and the fourth AR element may touch each other at a second intersection wall portion/contact region, and the second intersection wall portion/contact region may be engineered (e.g., thinned by etching or via mechanical thinning) to have a second engineered thickness. In certain embodiments, one or more walls of the third AR element may have a third thickness and one or more walls of the fourth AR element may have a fourth thickness. The second engineered thickness may be less than a sum of the third thickness and the fourth thickness.

In certain embodiments, the third thickness may be equivalent to the fourth thickness. In this case, the second engineered thickness may be equivalent to the third thickness or the fourth thickness.

In some embodiments, a width or diameter of the third AR element may be equivalent to a width or diameter of the fourth AR element. In other embodiments, the width or diameter of the third AR element may be different from the width or diameter of the fourth AR element.

The optical fiber may further include a support structure located in the interior region of the first AR element. The support structure may be formed as at least a portion of the walls of the first AR element. In this case, the walls of the first AR element may have a non-uniform wall thickness profile in a cross-sectional plane defining a shape of the support structure.

The support structure may have a non-uniform thickness profile. Further, the support structure may be positioned on the interior surface of the cladding structure. In certain embodiments, the third AR element and/or the fourth AR element may be positioned on the support structure.

In some embodiments, the first AR element (and/or the second AR element) may further include one or more additional walls that may divide the interior region of the first AR element into two or more cavities. In certain embodiments, the third AR element and the fourth AR element may be positioned on an additional wall.

In some embodiments, one or more of the first AR element and the second AR element may have a cross-sectional shape as one of: a circle, an ellipse, a truncated circle, a truncated ellipse, a lightbulb, a triangle, a square, a pentagon, a snowman, a hexagon, a heptagon, or an octagon.

In additional embodiments, the optical fiber may include one or more support walls that extend from the interior surface of the cladding structure. The support walls may be configured to position the first AR element and the second AR element closer to a center portion of the hollow interior fiber region and away from the cladding structure.

In accordance with further embodiments of the present disclosure, a method for making an optical fiber is disclosed. The method may include providing a cladding structure extending along a fiber length providing a hollow interior fiber region. The method may further include providing a first AR element and a second AR element distributed within the hollow interior fiber region. The first AR element and the second AR element may be formed as walled structures with one or more walls extending along the fiber length. Further, the first AR element and the second AR element may touch each other at an intersection wall portion/contact region. The method may further include engineering (e.g., thinning by etching or via mechanical thinning) the intersection wall portion/contact region to have an engineered thickness.

### DETAILED DESCRIPTION

The invention can be implemented in numerous ways, including as a process; an apparatus; a system; a combination of matter; a computer-assisted program embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘process’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of the present disclosure are directed to an anti-resonant (AR) hollow-core fiber (HCF). Anti-resonant (AR) hollow core fibers offer significant potential to replace solid-core standard silica fibers across a wide range of applications, particularly in communications. These AR hollow core fibers exhibit weak electromagnetic field overlap with the glass material, resulting in lower nonlinearity, higher damage thresholds, broader transmission windows, reduced Rayleigh scattering, and faster propagation speeds (lower latency) compared to solid-core fibers.

For AR hollow core fibers to achieve widespread adoption, they must exhibit attenuation comparable to or lower than state-of-the-art silica single-mode fibers and operate over a broadband spectral range (i.e., low losses for a wide range of wavelengths). This highlights the need for advanced systems and methods to design and manufacture ultralow-loss AR hollow core fibers.

In AR hollow core fibers, light confinement within the core is achieved by glass membranes of uniform (or nearly uniform) thickness surrounding the core, which confine light in air. These thin glass membranes, effectively repel the light field, resulting in negligible surface scattering loss. However, to minimize confinement loss, multiple layers of these glass membranes are required to form efficient AR elements that expel light. Here, we refer to AR elements as a structure of glass membranes that provide confinement. Over the years, several AR hollow core fiber geometries have been developed, featuring various AR element designs. A key issue in these fibers is the presence of glass nodes or contact regions that form when two AR elements come into contact (fuse) at the core boundary. These nodes create regions of glass with varying thickness and shape, introducing high-loss spectral resonances that increase fiber loss and narrow the transmission window. Consequently, efforts have focused on maintaining a thin and uniform thickness (thin, in this context, refers to a thickness smaller than the wavelength of propagating light within the fiber) of the AR elements impacting optical resonance conditions, particularly avoiding contact points among AR elements at the core boundary (see, for example the disclosures in U.S. Pat. Nos. 10,139,560 and 11,009,654). These fibers with non-touching AR elements provide lower attenuation than the AR hollow-core fiber with touching AR elements (see for example, “Hollow antiresonant fibers with reduced attenuation,” Optics Letters, vol. 39, pages 1853-1856 (2014)).

The inventions within the present disclosure provide AR hollow core fibers featuring touching AR elements, creating nodes within the core boundary. These nodes were previously thought to be undesirable because they were thought to support modes to which the core guided modes could couple, inducing high loss peaks across the fiber's spectral transmission window. To eliminate these issues, the present disclosure aims to “engineer” the thickness along the AR elements such that at the contact points between elements (nodes) the overall thickness/shape of the touching points can be controlled. While these fibers have touching AR elements, the touching points do not create unwanted resonances that efficiently couple to the fundamental air guided mode and/or other air guided modes. Thereby certain embodiments described herein can produce low loss AR hollow core fibers. Moreover, these embodiments can achieve other desirable properties such as single mode guidance. In one embodiment, the touching points (nodes) are engineered to have a thickness equal to the thickness of the thin membrane of the anti-resonant (AR) element, thereby maintaining a uniform thickness along the AR element even if the node is present. In another embodiment, the touching points (nodes) have a thickness smaller than the thickness of the AR elements membranes at the core boundary. In yet another embodiment, the touching points (nodes) have a thickness smaller than 2 times the thickness of the AR elements membranes at the core boundary.

The AR-HCF, as disclosed in the present disclosure, includes a hollow core and one or more anti-resonant (AR) elements. The AR-HCF may further include one or more support structures that may provide various functions such as, but not limited to, positioning various AR elements in a hollow interior fiber region, improving optical performance properties, providing structural support, or improving mechanical properties (including manufacturability, such as improved manufacturing tolerance and stability throughout the fiber-fabrication process) of the AR-HCF. Further, the support structures may provide additional anti-resonant behavior and are not limited to non-resonant structures.

It may be appreciated that in an AR-HCF, light or optical signal is guided in the hollow core as a result of anti-resonant properties of thin-walled structures (e.g., AR elements) extending along the length of the fiber. Since the light or optical signal is guided in a “hollow” core in an AR-HCF, as opposed to a solid/glass core in the case of a standard solid/glass core fiber, the speed of travel of optical signal (and hence the speed of signal transmission) in an AR-HCF is considerably greater than the speed of signal transmission in a solid/glass core optical. Specifically, since the optical signal travels through the hollow core in an AR-HCF, which is a gas or vacuum having an index of refraction (“n”) close to or equal to 1 (for example n=~1.000273 for air at 1550 nm), the optical signal travels through the AR-HCF at a speed that is equivalent to (or substantially equivalent to) the speed of light (as speed of signal in the medium=speed of light (“c”)/n). This is in contrast to the speed of optical signal in a solid/glass core fiber, which typically has an index of refraction in a range of 1.4-1.5, and hence offers a lower speed of transmission of the optical signal.

Furthermore, AR-HCFs offer various benefits over standard solid/glass core fibers including, but not limited to, high average and peak power capability, high damage thresholds, low latency, low non-linearities, lower dispersion, etc. Considering these advantages and the greater speed of signal transmission, many telecom service providers are adopting AR-HCFs for signal transmission, to provide enhanced services to their customers.

The present disclosure describes a novel design of an AR-HCF, which significantly enhances the structural integrity of the AR-HCF, while at the same time ensures that the optical resonance properties of the AR elements are not impacted or even are enhanced. The AR-HCF, as proposed in the present disclosure, may include one or more cladding structures providing a hollow interior fiber region extending a length of the fiber (e.g., along a fiber length) and multiple AR elements distributed around or in the interior fiber region, which forms a hollow core surrounded by AR elements. Further, such an AR-HCF may have any suitable size. In some embodiments, the hollow core size of an AR-HCF fiber is between 5× and 100× the guided wavelength. For example, the hollow core size of an AR-HCF fiber may be, but is not limited to, 5×, 10×, 20×, 30×, 50×, or 100× the guided wavelength.

The AR elements may include walled structures with walls that extend along the fiber length. In some aspects, the walls of the AR elements and/or the distribution of the AR elements may provide guiding of light in a central hollow interior region of the AR-HCF through anti-resonant optical phenomena. Further, some of the AR elements may be nested, including multiple times. As an illustration, one AR element may be located within an interior region bounded at least in part by walls of another AR element.

In some embodiments, the AR elements may have circular cross-section. In other embodiments, the AR elements may be non-circular in cross section. For example, the AR elements may be parabolic, elliptical, shaped like a snowman or figure “8”, a truncated circle, a truncated ellipse, a lightbulb, a triangle, a square, a pentagon, a hexagon, a heptagon, an octagon, or have other cross sections. Furthermore, nested AR elements may or may not lie on an imaginary line extending from the center of the AR-HCF. For example, an inner AR element and an outer AR element (e.g., in a nested arrangement) may not lie on the same imaginary line extending from the center of the AR-HCF.

In some aspects, one or more AR elements of the AR-HCF, as proposed in the present disclosure, may touch one or more adjacent AR elements at an “intersection wall portion” or a “contact region” or a “node”. In the present disclosure, the terms “intersection wall portion”, “contact region” and “node” are used interchangeably. The intersection wall portion/contact region/node, as used in the present disclosure, may be that portion of the walls of the AR elements that is common between the two touching adjacent AR elements.

It may be appreciated that the engineered intersection points of the AR elements may lead to enhanced manufacturability during the draw process. For example, larger diameter preforms may be possible due to the engineered intersection points compared to other designs that require non-touching elements.

It may be appreciated that by making the adjacent AR elements touch each other, the “intersection wall portion” where the two adjacent AR elements touch may have a thickness that may be greater than the thickness of the walls of the individual AR elements. For example, if the walls of a first AR element have a thickness “T1” and the walls of a second AR element (that touches the first AR element) have a thickness “T2”, the thickness of the intersection wall portion where the walls of the first and second AR elements touch each other may become “T1+T2”. In this example, T1 may be equivalent to or different from T2.

It may be appreciated that the thickness and refractive index of the walls of an AR element are carefully designed for providing anti-resonant properties for at least some wavelengths of interest. Consequently, if the thickness of the intersection wall portion becomes “T1+T2”, the light propagation properties of the AR elements may get disrupted or negatively affected. For example, if the thickness of each AR element wall is “T”, the intersection wall portion where the AR elements touch may have a thickness of approximately “2T” (although the exact thickness may be impacted by processing during the fiber draw process), which will affect the propagation of light through the AR-HCF when the propagating light interacts with the “double thickness” of the intersection wall portion. In some aspects, the “thick” intersection wall portion is undesirable because such a portion may support modes to which the core guided modes could couple, inducing high loss peaks across the fiber's spectral transmission window.

To prevent such a scenario from happening, the AR-HCF, as proposed in the present disclosure, has the intersection wall portion engineered (e.g., etched or “thinned” by etching, via mechanical processes, laser processing, or other appropriate methods) to have the same thickness as the rest of the walls of the AR elements. Continuing with the same example described above, the AR-HCF, as proposed in the present disclosure, has the intersection wall portion engineered such that the intersection wall portion has a thickness of “T” (as opposed to being “2T”), so that the light propagation properties of individual AR elements are not disrupted or negatively affected at the intersection wall portion.

In embodiments, the engineering of the intersection wall portion may be performed at the fiber preform stage, while the fiber preform is being drawn from the draw tower, and/or post fiber draw. In a preferred embodiment, the engineering of the intersection wall portion/contact region is engineered at the preform stage. Further, in some embodiments, dry etching, wet etching, laser processing, plasma etching, Reactive Ion Etching (RIE), Deep Reactive Ion Etching (DRIE), mechanical processing, or other appropriate method may be performed to engineer the intersection wall portion to achieve precise thickness profiles.

While performing a dry etch of the intersection wall portion, a vacuum chamber may be used to create a plasma, where gas molecules get ionized and bombard the substrate surface (i.e., the intersection wall portion), causing a chemical reaction that removes material selectively based on the chosen gas and its reactivity with the material. Such a process of etching has many advantages including, but not limited to, high precision and control over etch profile, anisotropic etching meaning the etch primarily occurs in the vertical direction, minimizing undercutting, suitable for complex micro-and nano-scale features, and/or the like.

In an exemplary embodiment, the engineering (thinning) of the intersection wall portion is performed by machining the preform and then drawing the preform from the tower. In another exemplary embodiment, the “thinned” intersection wall portion is created by extruding the glass preform using an extrusion process. It is known that extrusion is a mechanical shaping process where a softened glass or polymer billet is forced through a precision die to form a structured preform. In accordance with the present disclosure, the precision die can be specifically fabricated, which incorporates the dimensions (and shape) of the desired “thinned” intersection wall portion. It may be appreciated that by creating the thinned nodes via the extrusion process, non-symmetrical extrusion is possible. Stated another way, by using the extrusion process, it is possible to create preforms that do not have a perfectly symmetric geometry around the central axis. Once the preform is extruded, it can be loaded onto the fiber draw tower for fiber drawing.

In some aspects, in the fabrication process of the fiber, the touching of the AR elements can occur either in the preform creation stage, or the touching of the AR elements can occur during the fabrication process, e.g., through inflation. During the inflation process, after the fiber is drawn, gas pressure is applied to the hollow channels, which enables the AR elements to get properly placed/spaced around the hollow core and touch each other. Once the AR elements are properly placed and touch each other, the fiber is cooled.

The examples of the processing techniques described above to engineer the intersection wall portion/contact region should not be construed as limiting. The intersection wall portion may be engineering or “thinned” by any other known process, without departing from the scope of the present disclosure.

Furthermore, the present disclosure proposes a plurality of different designs of the AR-HCF, in which one or more adjacent AR elements (whether nested or otherwise) touch each other and the intersection wall portion is engineered. It may be appreciated that various aspects of the performance of an AR-HCF such as, but not limited to, the optical characteristics may be impacted by the placement and arrangement of the various AR elements. In certain embodiments, in addition to the AR elements described above, the AR-HCF may include one or more support structures, which may extend from the cladding structure and/or one or more of the AR elements.

At least one of the AR elements of the AR-HCF may be connected to the support structures described above. Such support structures may or may not provide AR properties directly. For example, a support structure may be relatively thick and may thus not operate as an anti-resonant element itself. However, such a support structure may position one or more AR elements, or portions thereof, within the AR-HCF to provide desired performance characteristics. More broadly, it is recognized herein that various aspects of the performance of an AR-HCF such as, but not limited to, the confinement of light within the interior fiber region may generally depend on the complete distribution of all associated elements of the AR-HCF including any support structures.

A support structure may generally have any shape suitable for positioning an AR element within an AR-HCF. Further, a support structure may be located at any location within an AR-HCF. In some embodiments, a support structure extends from one AR element to another. For example, a support structure may extend from or otherwise be a part of one or more AR elements. As an illustration, an AR element may have walls with a non-uniform thickness profile (e.g., as measured in a cross-sectional plane orthogonal to a direction along the fiber length). In this configuration, a support structure may be formed as a relatively thick portion of the walls of an AR element. It is contemplated herein that such a configuration may be suitable for, but not limited to, positioning a nested AR element within an interior region of another AR element.

In some embodiments, a support structure may be located between the cladding structure and one or more AR elements. For example, such a support structure may be formed as a rod, a pedestal, a tube, a slab with a rectangular cross section, a slab with a circular cross section, a slab with a cross section of less than a whole circle (such as half or a part of a circle), or a combination thereof. Further, such a support structure may be solid, porous, or hollow.

The use of the support structure(s) and/or the AR elements that touch adjacent AR elements in the AR-HCF, as described above, may provide various benefits including, but not limited to, providing robust alignment of elements within the AR-HCF, and providing high manufacturing tolerance and stability throughout the fiber-fabrication process as well as deployment.

It is contemplated herein that nomenclature used herein to separately describe AR elements and support structures as separate elements is merely illustrative and should not be interpreted as limiting the scope of the present disclosure. For example, the various elements of a fabricated AR-HCF (e.g., AR elements, cladding structures, support structures, and the like) may be fused together into a continuous fiber structure with a designed cross-sectional profile. In this way, the use of separate nomenclature herein to describe different aspects of the cross-sectional profile is merely for convenience of description. For example, some descriptions herein describe a support structure as extending from an AR element. However, such a support structure may be indistinguishable from the AR element such that it may also be accurate to describe the support structure as being integrated into and forming a part of the AR element. For example, a support structure may be integrated with an AR element in such a way that the AR element and the support structure are one cohesive element.

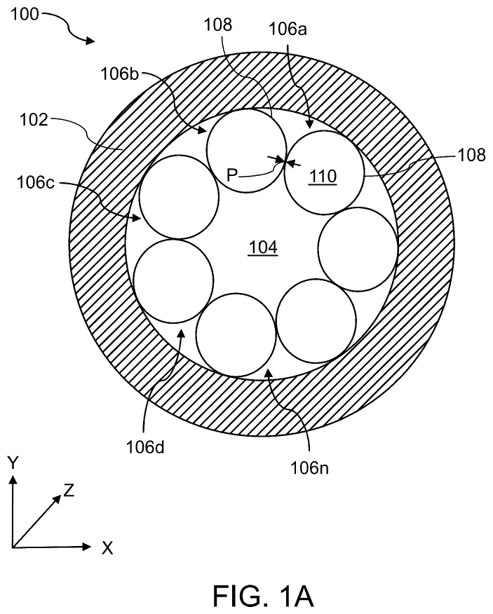

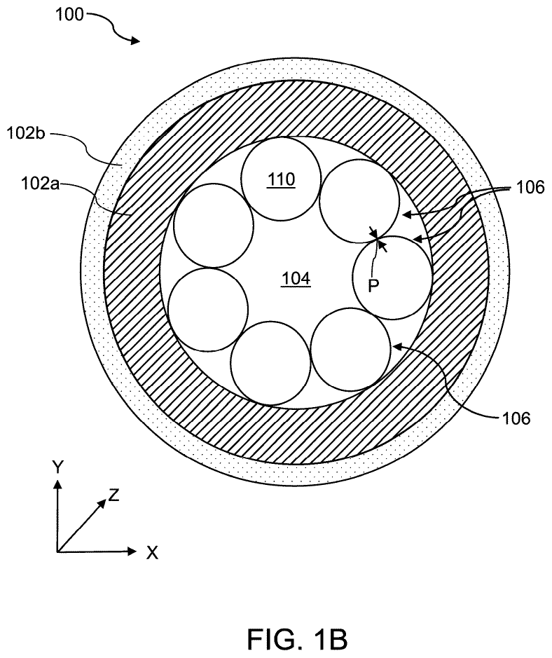

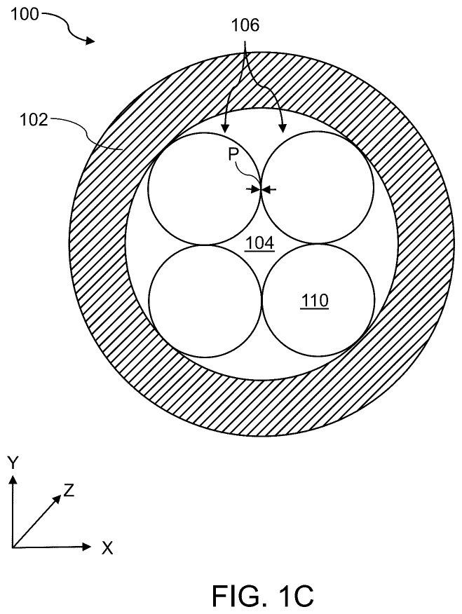

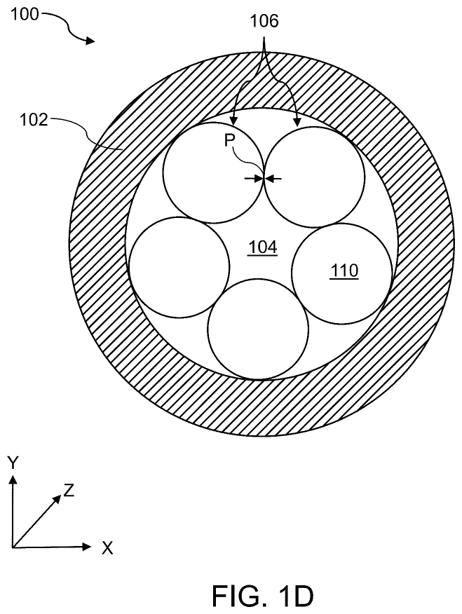

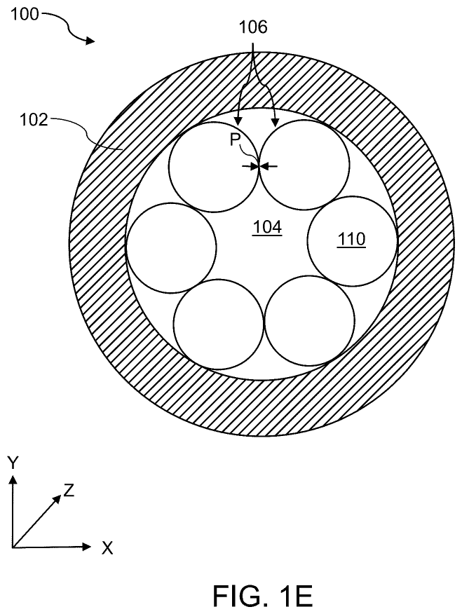

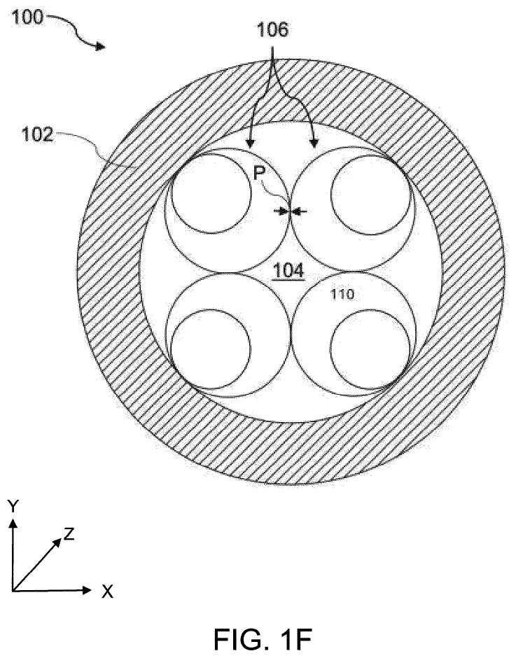

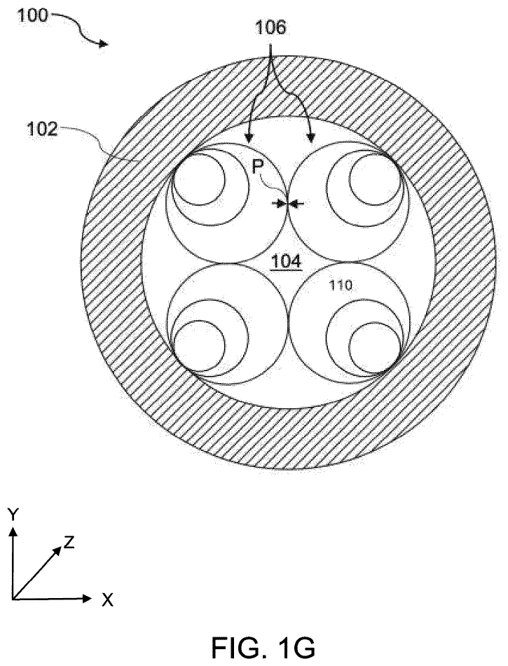

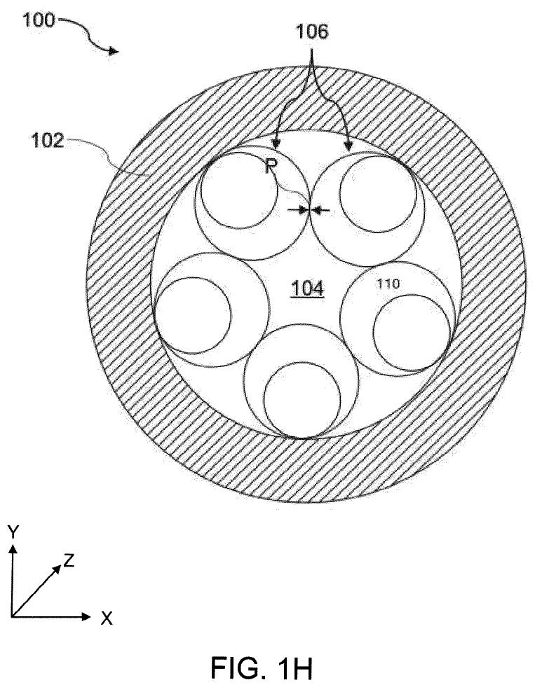

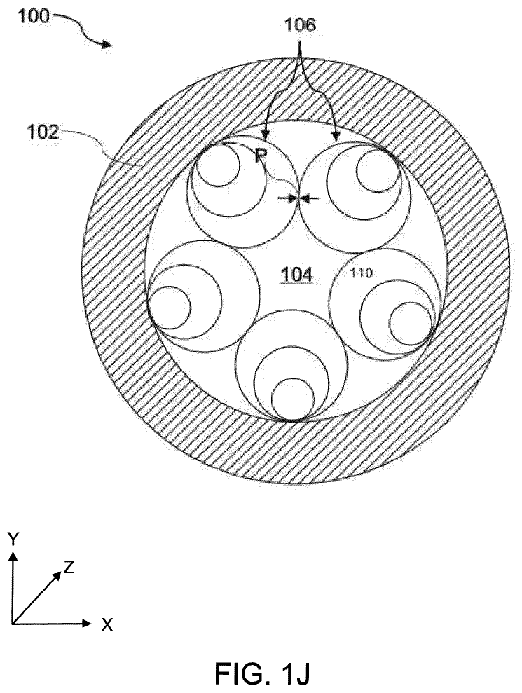

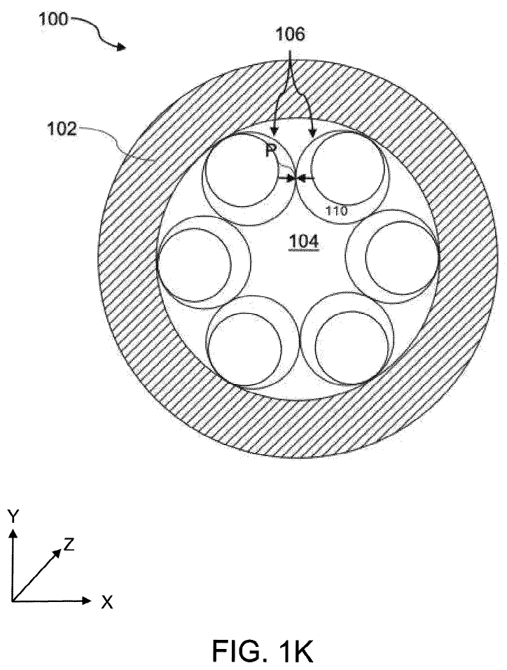

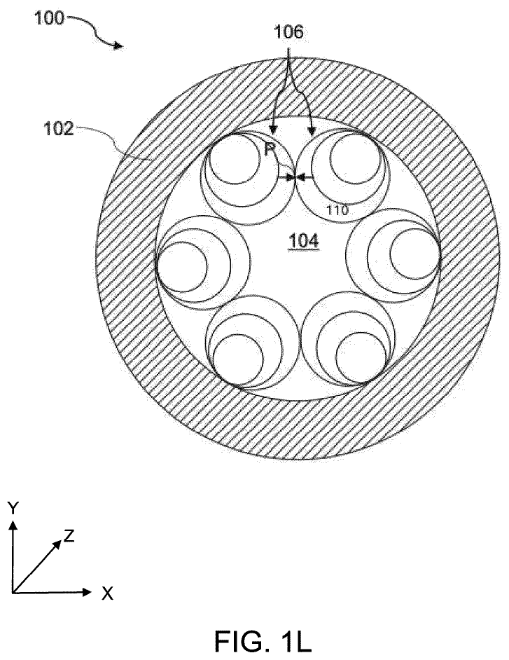

Referring now to FIGS. 1A-26, systems and methods providing AR-HCFs with AR elements that touch adjacent AR elements and/or support structures are described in greater detail, in accordance with one or more embodiments of the present disclosure.

FIG. 1A depicts a cross-sectional view of a first embodiment of an AR-HCF 100, in accordance with one or more embodiments of the present disclosure. In particular, FIG. 1A depicts a cross-section of the AR-HCF 100 in an X-Y plane, where a length of the AR-HCF 100 extends along the Z direction (e.g., a direction along the fiber length). It is to be understood that the AR-HCF 100 may generally be flexible and/or bend such that the fiber length need not extend along a straight line. In this way, the cross-sectional view depicted in FIG. 1A may correspond to a plane orthogonal to the fiber length at any selected location.

In some embodiments, the AR-HCF 100 may include one or more cladding structures 102 extending along a fiber length providing a core region 104. For example, FIG. 1A depicts the AR-HCF 100 with a single cladding structure 102 formed as a circular tube. The present disclosure is not limited to such a design of the AR-HCF. For example, FIG. 1B depicts a second embodiment of the AR-HCF 100 in which the AR-HCF 100 has two cladding structures 102a, 102b. The cladding structures 102a, 102b may be concentric, and the cladding structure 102a may have a lesser diameter than the diameter of the cladding structure 102b.

In certain embodiments, the AR-HCF 100 may include more than two cladding structures as well, without departing from the scope of the present disclosure. Accordingly, the illustration of the AR-HCF 100 depicted in FIGS. 1A and 1B should not be construed as limiting.

The AR-HCF 100 may further include a plurality of AR elements 106 a, 106 b, 106c, 106d, 106n (shown in FIG. 1A, collectively referred to as AR elements 106) distributed within the core region 104 provided by the cladding structures 102. The AR elements 106 may be configured to guide light along the fiber length in the core region 104. The AR-HCF 100 may generally have any number of AR elements 106, and the AR elements 106 may be evenly or unevenly distributed around a perimeter of the core region 104. For example, FIGS. 1A and 1B depict a non-limiting configuration of an AR-HCF 100 with seven AR elements 106 uniformly distributed around a perimeter of the core region 104 formed by the cladding structure 102. Further, in the exemplary embodiments depicted in FIGS. 1A and 1B, the AR elements 106 touch adjacent AR elements 106. For example, the AR element 106b touches the AR elements 106a and 106c, the AR element 106c touches the AR elements 106b, 106d, and so on, as shown in FIG. 1A. Further, in the exemplary embodiments depicted in FIGS. 1A and 1B, the AR elements 106 are positioned on an interior surface of the cladding structure 102.

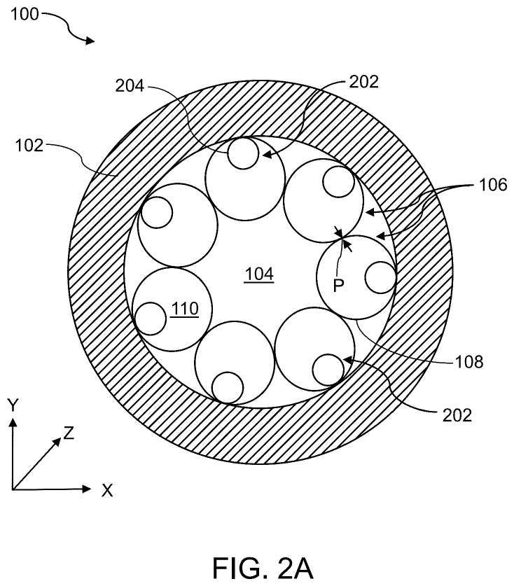

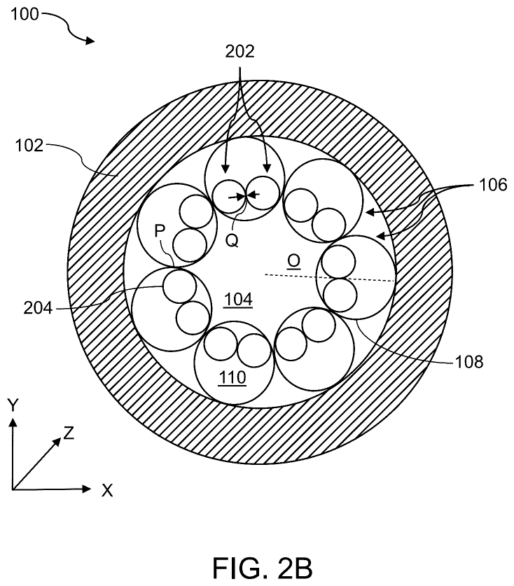

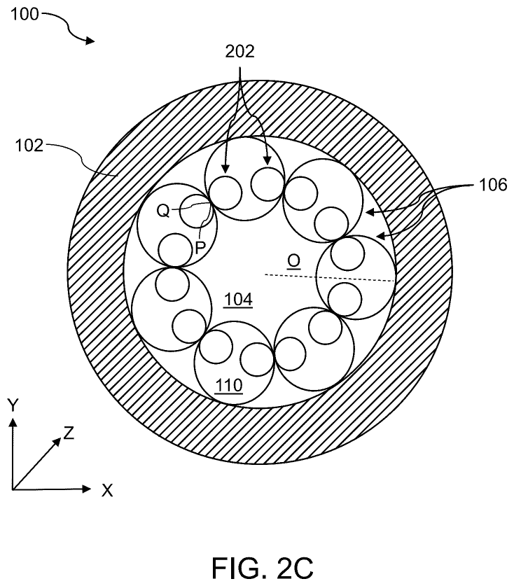

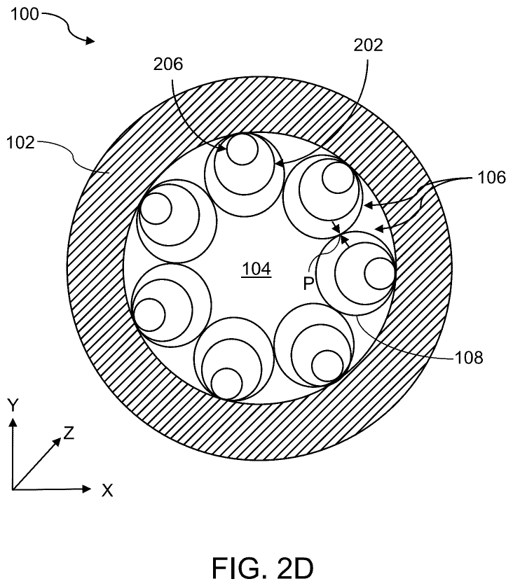

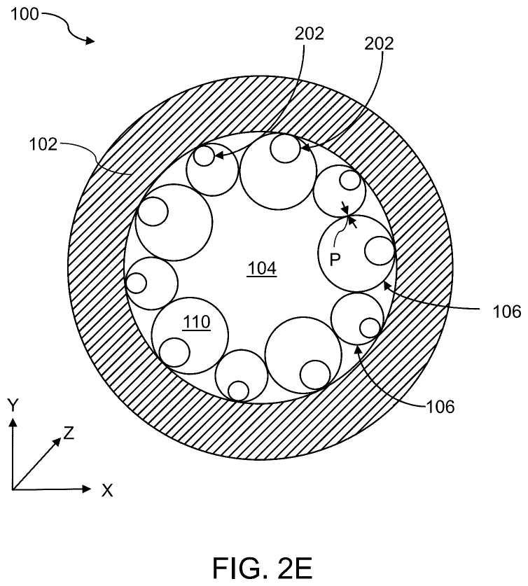

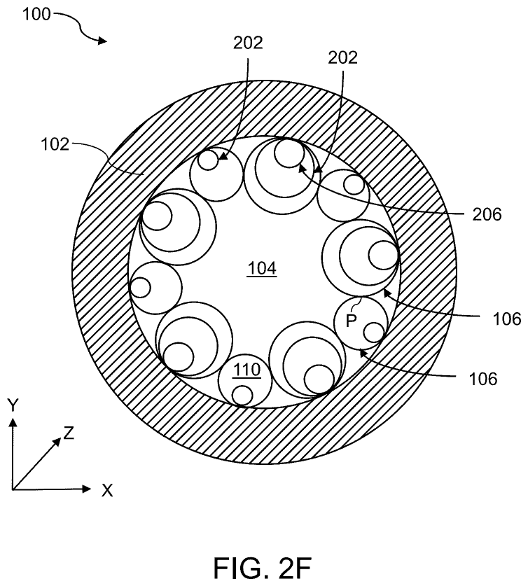

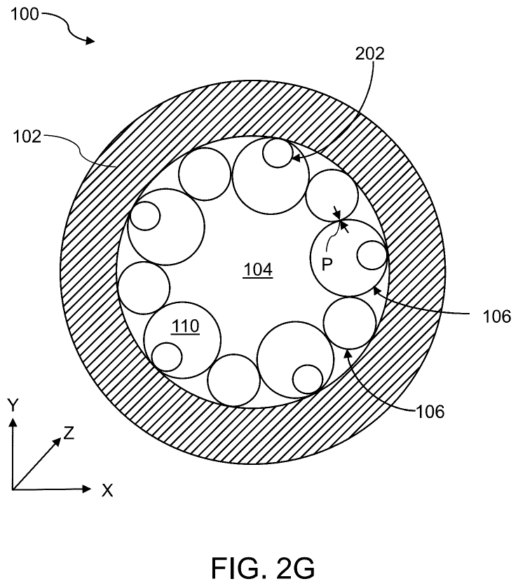

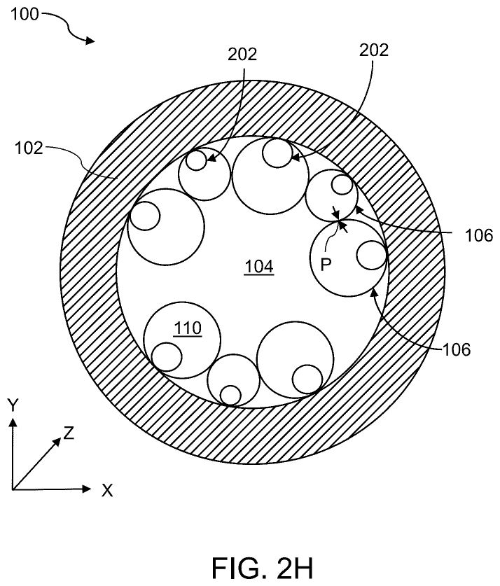

In some embodiments, there are 4-6 outer AR elements, which can be important for specific applications, such as for optimizing, for example, the mode field diameter, fiber outer diameter, bendability, bend loss, and/or fiber loss. A depiction of such an embodiment is shown in FIG. 1D, in which the AR-HCF 100 has 5 AR elements 106. In other embodiments, there may be 4 AR elements 106 in the AR-HCF 100. A depiction of such an embodiment is shown in FIG. 1C, in which the AR-HCF 100 has 4 AR elements 106. In yet another embodiment, the AR-HCF 100 may have 6 AR elements 106, as shown in FIG. 1E. Additional AR elements may be nested within an outer AR element 106. For example, there may be one AR element nested within the outer AR element, similar to the embodiment shown in FIG. 2A, two AR elements nested within the outer AR element, similar to the embodiment shown in FIG. 2D, or three or more AR elements nested within the outer AR element. The outer AR elements and the nested AR elements may be circles in cross section, ovals in cross section, or some other cross section (for example, a “snowman” cross section).

Additional embodiments with nested AR elements within an outer AR element are shown in FIGS. 1F-1L. FIG. 1F depicts a cross-sectional view of an embodiment with four outer AR elements and one nested AR element within each outer AR element. FIG. 1G depicts a cross-sectional view of an embodiment with four outer AR elements and two nested AR elements within each outer AR element. FIG. 1H depicts a cross-sectional view of an embodiment with five outer AR elements and one nested AR element within each outer AR element. FIG. 1J depicts a cross-sectional view of an embodiment with five outer AR elements and two nested AR elements within each outer AR element. FIG. 1K depicts a cross-sectional view of an embodiment with six outer AR elements and one nested AR element within each outer AR element. FIG. 1L depicts a cross-sectional view of an embodiment with six outer AR elements and two nested AR elements within each outer AR element.

The AR-HCF 100 may include more or less than 4, 5, 6 and 7 AR elements 106 as shown in FIGS. 1A-1E and include additional nested AR elements, without departing from the scope of the present disclosure.

In some aspects, each AR element 106 may be formed as a walled structure with one or more walls 108 extending along the fiber length (e.g., along the Z direction in the figures). The walls 108 may be characterized by a thickness (or a thickness profile) in a cross-sectional plane (e.g., an X-Y plane in FIGS. 1A and 1B). Further, the thickness of any of the walls 108, or portions thereof, may be selected to provide anti-resonant properties to confine and guide light through the core region 104. In this way, at least some of the walls 108, or portions thereof, may provide confinement of light through anti-resonant phenomena.

In some aspects, the thickness of the walls 108 (and/or their refractive index) is selected/designed to provide anti-resonant properties for at least some wavelengths of interest. The walls 108 of all the AR elements 106 may have the same thicknesses (as shown in FIGS. 1A and 1B), or may have different thicknesses. For example, in certain embodiments, the walls 108 of the AR element 106a may have a thickness “T1” and the walls 108 of the AR element 106b may have a thickness “T2”, where T1 may be different from T2. In other embodiments, T1 may be equivalent to T2. In addition, the thickness of any one AR element may not be uniform. In such a situation, T1 and T2 shall be the largest thickness of each AR element.

Further, the AR elements 106 may have the same cross-sectional structures (as shown in FIGS. 1A-1E) and/or dimensions (e.g., width or diameter), or may have different structures and/or dimensions. Each AR element 106 may generally have any cross-sectional shape including, but not limited to, a circle (as shown in FIGS. 1A-1E), an ellipse, a truncated circle, a truncated ellipse, a lightbulb, a triangle, a square, a pentagon, a hexagon, a heptagon, an octagon, or the like.

In some embodiments, the walls 108 of each AR element 106 may be arranged to provide an interior region 110 (e.g., an interior cavity). In this way, the interior region 110 may be at least partially bounded by the walls 108 of at least one AR element 106. The interior region 110 may be empty (as shown in FIGS. 1A-1E), or may include one or more additional AR elements and/or support structures, as described later in the description below.

The core region 104, as well as any interior cavities of other structures (e.g., the AR elements 106, the cladding structures 102, or the like) may be under vacuum or filled with any gas (e.g., ambient air, nitrogen, argon, or any selected composition). Furthermore, the various components of the AR-HCF 100 including, but not limited to, the AR elements 106 (e.g., the walls 108) and/or the cladding structures 102 may be formed from any suitable material such as, but not limited to, a glass or a polymer. One or more AR elements 106 may be formed from a different material than other AR elements 106. As an example, any such components of the AR-HCF 100 may be formed from silica glass, doped silica glass, chalcogenide glass, fluoride glass, or the like. Further, any such components may be un-doped or doped with one or more dopants. Additionally, the AR-HCF 100 may be formed from a single material or may have different components formed from different materials. Furthermore, in certain embodiments, the index of refraction of one or more AR elements 106 may have a different index of refraction from other AR elements 106.

It may be appreciated that by making the adjacent AR elements 106 touch each other, an intersection wall portion “P” (or a contact region “P” or node “P”, as shown in FIGS. 1A-1E) where the two adjacent AR elements 106 touch may have a thickness that may be greater than the thickness of the walls 108 of the individual AR elements 106. For example, if the walls 108 of the AR element 106a have a thickness “T1” and the walls 108 of the AR element 106b (that touches the AR element 106a) have a thickness “T2”, the thickness of the intersection wall portion “P” where the walls 108 of the AR elements 106a, 106b touch each other may become “T1+T2”. If T1=T2 (=T), then the intersection wall portion “P” may have double the thickness of the walls 108 (i.e., 2T). In addition, the thickness of any one AR element may not be uniform. In such a situation, T1 and T2 shall be the largest thickness of each AR element.

As described above, the thickness and refractive index of the walls 108 of the AR elements 106 are carefully designed for providing anti-resonant properties for at least some wavelengths of interest. Consequently, if the thickness of the intersection wall portion “P” becomes 2T, the light propagation properties of the AR elements 106 a, 106 b may get disrupted or negatively affected. To prevent such a scenario from happening, the AR-HCF 100, as proposed in the present disclosure, has the intersection wall portion “P” engineered to have less than a thickness of 2T. In embodiments, the intersection wall portion “P” has the same thickness “T” as the thickness of the other walls 108 of the AR elements 106a, 106b (or has a thickness “T” that is less than a sum of “T1+T2”, if T1 is different from T2). In other embodiments, the thickness of the intersection wall portion “P” is less than 2T and greater than the thickness of the walls 108 of the AR elements 106a and 106b. In still other embodiments, the thickness of the intersection wall portion “P” is less than 2T and less than the thickness of the walls 108 of the AR elements 106a and 106b. The engineering of the intersection wall portion “P” may ensure that the light propagation properties of the individual AR elements 106a, 106b are not disrupted or negatively affected at the intersection wall portion “P”.

As described above, the engineering of the intersection wall portion may be performed at the fiber preform stage, while the fiber preform is being drawn from the draw tower, and/or post fiber draw. In a preferred embodiment, the engineering of the intersection wall portion/contact region is engineered at the preform stage. Further, in some embodiments, dry etching, wet etching, laser processing, plasma etching, Reactive Ion Etching (RIE), Deep Reactive Ion Etching (DRIE), mechanical processing, or other appropriate method may be performed to engineer the intersection wall portion to achieve precise thickness profiles.

The AR-HCF 100 may have different cross-sectional designs, where one or more AR elements 106 touch adjacent AR elements 106 and the intersection wall portions “P” are engineered. Examples of different designs of the AR-HCF 100 are depicted in FIGS. 2A-8, 10, 21 and 26, and described below. The designs of the AR-HCF 100, as depicted in FIGS. 1A-8, 10, 21 and 26, are for illustrative purpose and should not be construed as limiting. The AR-HCF 100 may have any other design as well, where one or more adjacent AR elements 106 touch each other and the intersection wall portions “P” are engineered, without departing from the scope of the present disclosure.

FIG. 2A depicts a cross-sectional view of a twelfth embodiment of the AR-HCF 100, in accordance with one or more embodiments of the present disclosure. The AR-HCF 100 depicted in FIG. 2A is substantially similar to the AR-HCF 100 depicted in FIG. 1A, however the AR-HCF 100 depicted in FIG. 2A may further include one or more additional AR elements 202 that may be “nested” or disposed within the AR elements 106. Specifically, the AR elements 202 may be located within the interior region 110 bounded by the walls 108 of the AR elements 106.

In some embodiments, the AR elements 202 may be made of similar material as the AR elements 106. In other embodiments, one or more AR elements 202 may be made of a material that may be different from the material of the AR elements 106. Further, the AR elements 202 may have the same cross-sectional shape as the AR elements 106, or may have different shapes. In the exemplary embodiment depicted in FIG. 2A, each AR element 202 is circular in cross-sectional shape (similar to the cross-sectional shape of the AR elements 106), with a diameter of each AR element 202 substantially less than the diameter of the AR elements 106.

Furthermore, each AR element 202 may have the same or different refractive index as the AR elements 106, and may be under vacuum or filled with any gas (e.g., ambient air, nitrogen, argon, or any selected composition). In addition, walls 204 of each AR element 202 may have the same or different thickness than the walls 108 of the AR elements 106. Further, in certain embodiments, each AR element 202 may have the same dimensions (e.g., width or diameter) as the other AR elements 202. In other embodiments, one or more AR elements 202 may have different dimensions than the other AR elements 202. Further, AR elements may be nonuniform in thickness.

The embodiment of FIG. 2A shows the AR-HCF 100 as having seven AR elements 202, where one AR element 202 is located in the interior region 110 of each AR element 106. Further, each AR element 202 is connected to or positioned on the interior surface of the cladding structure 102 at the same location/point where the corresponding AR element 106 is connected to the cladding structure 102. Such depiction should not be construed as limiting, and the AR-HCF 100 may have more than one AR element 202 located in each AR element 106, or one or more AR elements 106 may not have any AR element 202, or the AR elements 202 may not be connected to the cladding structure 102 (and may be connected to or positioned on the walls of the AR elements 106), as described later in the description below.

In the AR-HCF 100 depicted in FIG. 2A, adjacent AR elements 106 touch each other at the intersection wall portion “P”, similar to the AR-HCF 100 described above in conjunction with FIG. 1A. In this case as well, the intersection wall portion “P” is engineered to have a thickness equivalent to the thickness of the remaining walls 108 of the AR elements 106.

FIG. 2B depicts a cross-sectional view of a thirteenth embodiment of the AR-HCF 100, in accordance with one or more embodiments of the present disclosure. The AR-HCF 100 depicted in FIG. 2B is substantially similar to the AR-HCF 100 depicted in FIG. 2A, however the AR-HCF 100 depicted in FIG. 2B may include two AR elements 202 located in the interior region 110 of each AR element 106. Further, in the AR-HCF 100 of FIG. 2B, the AR elements 202 are not connected to the cladding structure 102, but are rather connected to the walls 108 of the corresponding AR elements 106.

Furthermore, in the AR-HCF 100 of FIG. 2B, the AR elements 202 are not aligned to an imaginary central line “O” that connects the center point of the AR-HCF 100 (or the center point of the core region 104) with the connection point/location where the AR elements 106 touch the cladding structure 102. In the AR-HCF 100 of FIG. 2B, the AR elements 202 are aligned with a slight offset relative to the imaginary central line “O”.

In some embodiments, in the AR-HCF 100 of FIG. 2B, the AR elements 202 located in the interior region 110 of each AR element 106 may touch each other at an intersection wall portion “Q”. The intersection wall portion “Q” may be engineered similar to the intersection wall portion “P” as described above, such that the thickness of the intersection wall portion “Q” may be equivalent to the thickness of the walls 204 of the AR elements 202 (or less than a sum of thicknesses of individual adjacent “touching” AR elements 202 if their thicknesses are different). In this manner, any wall portion where the AR elements 202 or the AR elements 106 touch each other is engineered, to ensure that the light propagation properties of individual AR elements are not disrupted or negatively affected at the corresponding intersection wall portion.

FIG. 2C depicts a cross-sectional view of a fourteenth embodiment of the AR-HCF 100, in accordance with one or more embodiments of the present disclosure. The AR-HCF 100 depicted in FIG. 2C is substantially similar to the AR-HCF 100 depicted in FIG. 2B, however in the AR-HCF 100 depicted in FIG. 2C, the two AR elements 202 located in the interior region 110 of each AR element 106 may not touch each other. Instead, the two AR elements 202 may touch the “engineered” intersection wall portions “P” of each AR element 106. Consequently, as shown in FIG. 1C, an AR element 202 nested in an AR element 106 may touch another AR element 202 that may be nested in an adjacent AR element 106. In this case, the intersection wall portions “P” and “Q” may coincide, which together may be engineered to have the same thickness as the rest of the walls 108 of each AR element 106 (or any thickness less than the thickness of the sum of the wall thicknesses added together).

FIG. 2D depicts a cross-sectional view of a fifteenth embodiment of the AR-HCF 100, in accordance with one or more embodiments of the present disclosure. The AR-HCF 100 depicted in FIG. 2D is substantially similar to the AR-HCF 100 depicted in FIG. 2A, however in the AR-HCF 100 depicted in FIG. 2D, each AR element 106 may have two nested AR elements 202 and 206 located in the interior region 110 defined by the walls 108 of the AR element 106.

The AR element 206 may be similar to or different from the AR element 106 and/or the AR element 202. In the exemplary embodiment depicted in FIG. 2D, the AR element 206 may be located in an interior region defined by the walls 204 of the AR element 202, which may itself be located in the interior region 110 defined by the walls 108 of the AR element 106. A diameter of the AR element 206 may be less than a diameter of the AR element 202, which in turn may be less than the diameter of the AR element 106. Furthermore, the AR element 202 and the AR element 206 may be connected to the cladding structure 102 at the same point/location where the corresponding AR element 106 connects to the cladding structure 102.

It may be appreciated from the description above that in this case, the nested AR element 202 may itself include another nested AR element 206.

Similar to the embodiments described above, in the AR-HCF 100 of FIG. 2D as well, the intersection wall portion “P” may be engineered to have the same thickness as the thickness of the rest of the walls 108 of the AR elements 106 (or any thickness less than the thickness of the sum of the wall thicknesses added together).

FIG. 2E depicts a cross-sectional view of a sixteenth embodiment of the AR-HCF 100, in accordance with one or more embodiments of the present disclosure. The AR-HCF 100 depicted in FIG. 2E is substantially similar to the AR-HCF 100 depicted in FIG. 2A, however in the AR-HCF 100 depicted in FIG. 2E, adjacent AR elements 106 that touch each other may be of different sizes (e.g., of different diameters or widths). Further, the AR elements 202 nested in adjacent AR elements 106 may also be of different sizes (e.g., of different diameters or widths). For example, a smaller AR element 106 may have a smaller nested AR element 202, and a relatively larger AR element 106 may have a relatively larger nested AR element 202.

Similar to the embodiments described above, in the AR-HCF 100 of FIG. 2E as well, the intersection wall portion “P” (where the larger and smaller AR elements 106 touch) may be engineered to have the same thickness as the thickness of the rest of the walls 108 of the AR elements 106 (or any thickness less than the thickness of the sum of the wall thicknesses added together).

FIG. 2F depicts a cross-sectional view of a seventeenth embodiment of the AR-HCF 100, in accordance with one or more embodiments of the present disclosure. The AR-HCF 100 depicted in FIG. 2F is substantially similar to the AR-HCF 100 depicted in FIGS. 2D and 2E. Specifically, in the AR-HCF 100 depicted in FIG. 2F, the “larger” AR element 106 may include the AR elements 202 and 206, and the relatively “smaller” adjacent AR element 106 may include only the AR element 202 (and may not include the AR element 206). Further, the AR element 206 may have a lesser diameter than the diameter of the AR element 202 that is nested in “larger” AR element 106. In addition, the diameter of the AR element 202 that is nested in the “smaller” adjacent AR element 106 may be less than the diameter of the AR element 206.

Similar to the embodiments described above, in the AR-HCF 100 of FIG. 2F as well, the intersection wall portion “P” (where the larger and smaller AR elements 106 touch) may be engineered to have the same thickness as the thickness of the rest of the walls 108 of the AR elements 106 (or any thickness less than the thickness of the sum of the wall thicknesses added together).

FIG. 2G depicts a cross-sectional view of an eighteenth embodiment of the AR-HCF 100, in accordance with one or more embodiments of the present disclosure. The AR-HCF 100 depicted in FIG. 2G is substantially similar to the AR-HCF 100 depicted in FIG. 2E, however in the AR-HCF 100 of FIG. 2G, the “smaller” AR element 106 may not include the nested AR element 202, and the relatively “larger” adjacent AR element 106 may include the nested AR element 202. Similar to the embodiments described above, in the AR-HCF 100 of FIG. 2G as well, the intersection wall portion “P” (where the larger and smaller AR elements 106 touch) may be engineered to have the same thickness as the thickness of the rest of the walls 108 of the AR elements 106 (or any thickness less than the thickness of the sum of the wall thicknesses added together).

FIG. 2H depicts a cross-sectional view of a nineteenth embodiment of the AR-HCF 100, in accordance with one or more embodiments of the present disclosure. The AR-HCF 100 depicted in FIG. 2H is substantially similar to the AR-HCF 100 depicted in FIG. 2E, however in the AR-HCF 100 of FIG. 2H, the adjacent smaller and larger AR elements 106 may not be located/present on the entire circumference/interior perimeter of the cladding structure 102, but the adjacent smaller and larger AR elements 106 may be located on a portion of the circumference/interior perimeter of the cladding structure 102. Consequently, some portion of the circumference/interior perimeter of the cladding structure 102 may not be enclosed by any AR element 106 in the AR-HCF 100 of FIG. 2H.

Similar to the embodiments described above, in the AR-HCF 100 of FIG. 2H as well, the intersection wall portion “P” (where the larger and smaller AR elements 106 touch) may be engineered to have the same thickness as the thickness of the rest of the walls 108 of the AR elements 106 (or any thickness less than the thickness of the sum of the wall thicknesses added together).

It may be appreciated from the depiction of FIG. 2H that in certain embodiments, all the AR elements 106 may not touch adjacent AR elements, but only a subset of AR elements 106 may touch the adjacent AR elements. For example, in some embodiments, an AR element 106 may touch one or two adjacent AR elements, and another AR element 106 may not touch any adjacent AR element.

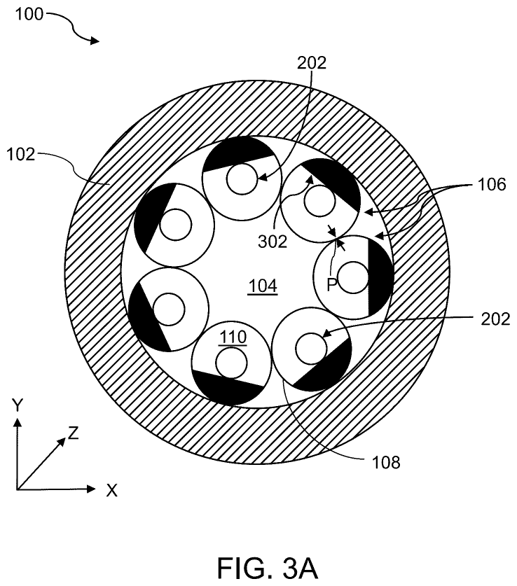

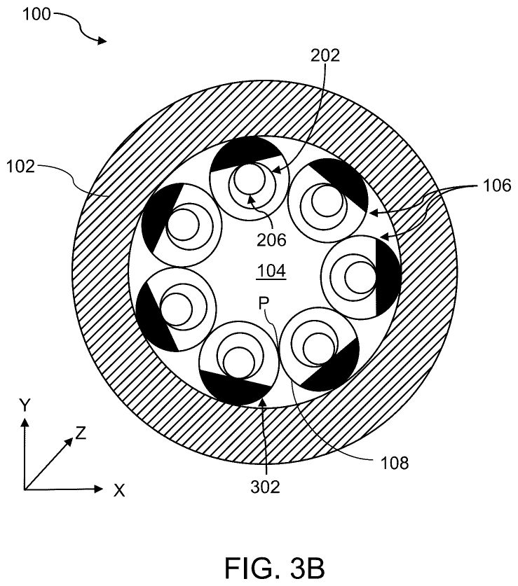

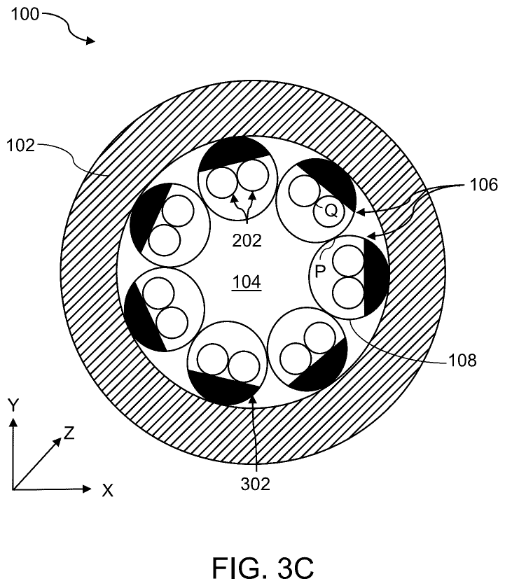

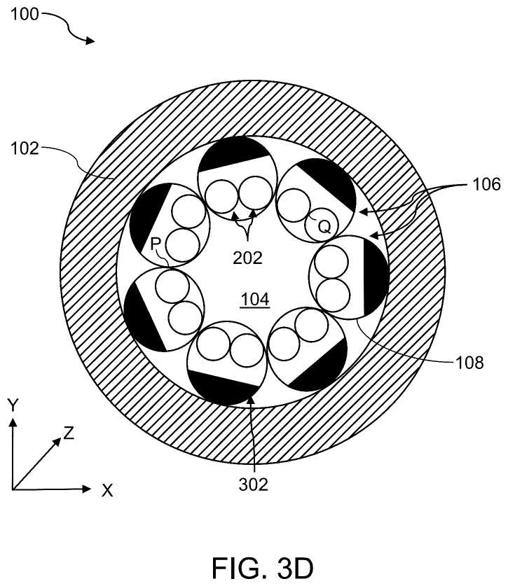

FIG. 3A depicts a cross-sectional view of a twentieth embodiment of the AR-HCF 100, in accordance with one or more embodiments of the present disclosure. In addition to the components depicted in FIG. 2A and described above, the AR-HCF 100 of FIG. 3A may include one or more support structures 302, which may position at least one AR element 106 within the AR-HCF 100. For example, at least one AR element 106 may be connected to at least one support structure 302. The support structures 302 may generally be formed as or be in contact with (or positioned on) the interior surface of the cladding structures 102 and/or any of the AR elements 106.

The support structures 302 may extend along the fiber length and may generally have any shape suitable for positioning one or more connected AR elements 106 within the core region 104 of the AR-HCF 100 such as, but not limited to, a circle, an ellipse, a truncated circle, a truncated ellipse, or any multi-faced shape. Further, a support structure 302 may be attached to or incorporated as part of an AR element 106 or the cladding structure 102. In some embodiments, a support structure 302 is formed as a portion of a wall 108 of an AR element 106. Put another way, an AR element 106 may have a wall 108 with a non-uniform thickness profile, where a portion of the wall 108 (e.g., a relatively thick portion) may form a support structure 302. In this manner, the support structure 302 may have a non-uniform thickness profile. In this configuration, the non-uniform thickness profile of a wall 108 may define a shape of the support structure 302. It is thus noted that while various figures throughout the present disclosure may depict the support structures 302 and the walls 108 as separate elements, this is merely illustrative of some embodiments and not limiting. Rather, any of the support structures 302 may be formed directly as part of a wall 108.

Different support structures 302 may be formed from a different material than other support structures 302. Further, the support structures 302 may be formed of the same material as the AR elements 106, or may be formed of a different material. For example, a support structure 302 may be formed from a different material than a connected AR element 106. Furthermore, in certain embodiments, the index of refraction of the AR elements 106 may be different from the index of refraction of the support structures 302. In addition, one of more support structure 302 may have a different index of refraction from other support structures 302.

In the AR-HCF 100 of FIG. 3A, the support structure 302 is connected to the interior surface of the cladding structure 102 and is located in the interior region 110. Further, the nested AR elements 202 may be positioned on the support structure 302, as opposed to being directly connected to the cladding structure 102 as depicted in FIG. 2A and described above.

In the exemplary embodiment depicted in FIG. 3A, the support structures 302 are located between the cladding structure 102 and the AR elements 106. Such support structures 302 may thus position one or more AR elements 106 (or sets of nested AR elements) within the core region 104 of the AR-HCF 100, and may further control the optical performance, improve structural stability, and/or improve manufacturability of the AR-HCF 100. In this case, the inner radius of curvature of each support structure 302 may be similar to the outer radius of curvature of each AR element 106 such that the support structure 302 optimizes surface contact with the AR element 106. The shape of the support structure 302 may be tailored based on fiber-draw parameters, such as draw speed, draw tension, surface tension, draw ratio, temperature, AR-element material, and differential pressures. The support structure 302 may be chosen to produce a specific, optimized geometry in the final hollow-core fiber. These improvements can aid manufacturing tolerance and stability throughout the fiber-fabrication process.

A support structure 302 may be solid, porous, or hollow. Similar to the AR elements 106, a porous or hollow support structure 302 may also be under vacuum or filled with any gas (e.g., ambient air, nitrogen, argon, or any selected composition). Furthermore, similar to the embodiments described above, in the AR-HCF 100 of FIG. 3A as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together).

FIG. 3B depicts a cross-sectional view of a twenty-first embodiment of the AR-HCF 100, in accordance with one or more embodiments of the present disclosure. The AR-HCF 100 of FIG. 3B is substantially similar to the AR-HCF 100 depicted in FIGS. 2D and 3A, however in the AR-HCF 100 of FIG. 3B, the nested AR elements 202 and 206 may be positioned on the support structure 302, as opposed to being directly connected to the cladding structure 102. Similar to the embodiments described above, in the AR-HCF 100 of FIG. 3B as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together).

FIG. 3C depicts a cross-sectional view of a twenty-second embodiment of the AR-HCF 100, in accordance with one or more embodiments of the present disclosure. The AR-HCF 100 of FIG. 3C is substantially similar to the AR-HCF 100 depicted in FIGS. 2B and 3A, however in the AR-HCF 100 of FIG. 3C, the two adjacent AR elements 202 may be positioned on the support structure 302, as opposed to being directly connected to the walls 108 of the AR element 106. Similar to the embodiments described above, in the AR-HCF 100 of FIG. 3C as well, the intersection wall portion “P” (where the adjacent AR elements 106 touch) and the intersection wall portion “Q” (where the adjacent AR elements 202 touch) may be engineered to have the same thickness as the thickness of the rest of the walls of the respective AR elements 106 and AR elements 202 (or any thickness less than the thickness of the sum of the wall thicknesses added together).

FIG. 3D depicts a cross-sectional view of a twenty-third embodiment of the AR-HCF 100, in accordance with one or more embodiments of the present disclosure. The AR-HCF 100 of FIG. 3D is substantially similar to the AR-HCF 100 depicted in FIG. 3C, however in the AR-HCF 100 of FIG. 3D, the two adjacent AR elements 202 may be positioned on the walls 108 of the AR element 106, as opposed to being positioned on the support structure 302. In this case, the support structures 302 may not be used to position the AR elements 202, but may provide additional functions such as, but not limited to, mechanical stability, improving optical performance properties, or the like. These improvements can aid manufacturing tolerance and stability throughout the fiber-fabrication process.

Similar to the embodiments described above, in the AR-HCF 100 of FIG. 3D as well, the intersection wall portion “P” (where the adjacent AR elements 106 touch) and the intersection wall portion “Q” (where the adjacent AR elements 202 touch) may be engineered to have the same thickness as the thickness of the rest of the walls of the respective AR elements 106 and AR elements 202 (or any thickness less than the thickness of the sum of the wall thicknesses added together).

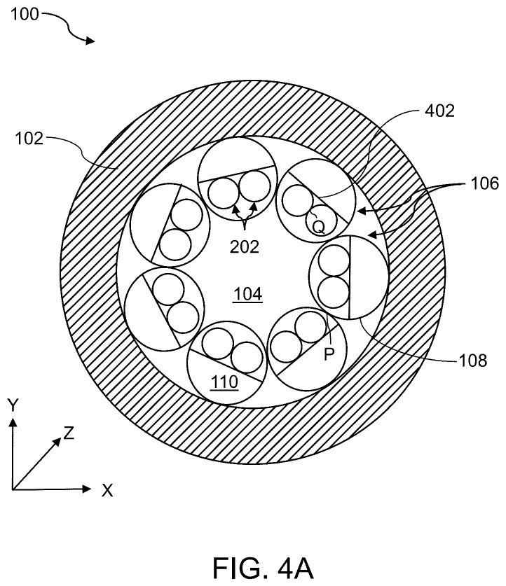

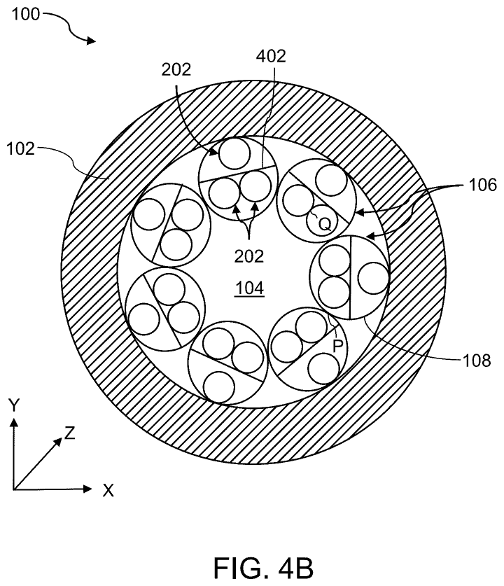

FIG. 4A depicts a cross-sectional view of a twenty-fourth embodiment of the AR-HCF 100, in accordance with one or more embodiments of the present disclosure. The AR-HCF 100 of FIG. 4A is substantially similar to the AR-HCF 100 depicted in FIG. 2B, however in the AR-HCF 100 of FIG. 4A, one or more AR elements 106 may include one or more additional walls 402 that may divide the interior region 110 into two or more cavities. For example, as shown in FIG. 4A, each AR element 106 may include an additional wall 402 that may divide the interior region 110 into two equally-sized semicircular cavities.

The additional wall 402 may be similar to the walls 108, and may have the same or different thickness. Further, in the exemplary embodiment depicted in FIG. 4A, the nested AR elements 202 are positioned on the additional wall 402, as opposed to being positioned on the wall 108 as depicted in FIG. 2B and described above.

Similar to the embodiments described above, in the AR-HCF 100 of FIG. 4A as well, the intersection wall portion “P” (where the adjacent AR elements 106 touch) and the intersection wall portion “Q” (where the adjacent AR elements 202 touch) may be engineered to have the same thickness as the thickness of the rest of the walls of the respective AR elements 106 and AR elements 202 (or any thickness less than the thickness of the sum of the wall thicknesses added together).

FIG. 4B depicts a cross-sectional view of a twenty-fifth embodiment of the AR-HCF 100, in accordance with one or more embodiments of the present disclosure. The AR-HCF 100 of FIG. 4B is substantially similar to the AR-HCF 100 depicted in FIG. 4A, however in the AR-HCF 100 of FIG. 4B, one or more additional AR elements 202 may be located in the interior region 110 and connected to the cladding structure 102. In an exemplary embodiment, in this case, the AR element 202 that is connected to the cladding structure 102 may be located in a different cavity (e.g., a first cavity) formed by the additional wall 402 in the interior region 110 than the cavity (e.g., a second cavity) where the adjacent “touching” AR elements 202 are located. As described above, the adjacent “touching” AR elements 202 may be positioned on the additional wall 402.

Similar to the embodiments described above, in the AR-HCF 100 of FIG. 4B as well, the intersection wall portion “P” (where the adjacent AR elements 106 touch) and the intersection wall portion “Q” (where the adjacent AR elements 202 touch) may be engineered to have the same thickness as the thickness of the rest of the walls of the respective AR elements 106 and AR elements 202 (or any thickness less than the thickness of the sum of the wall thicknesses added together).

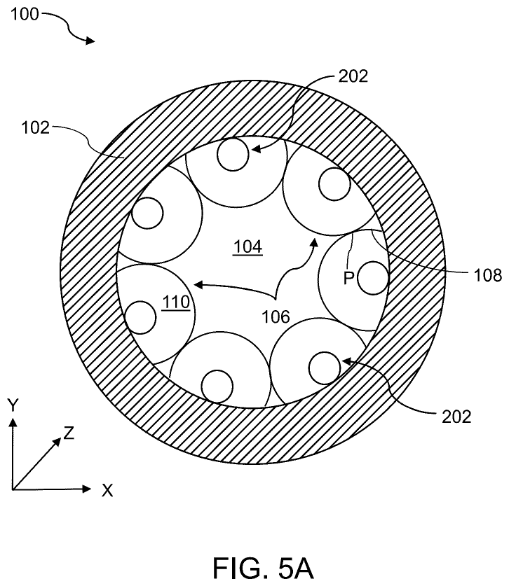

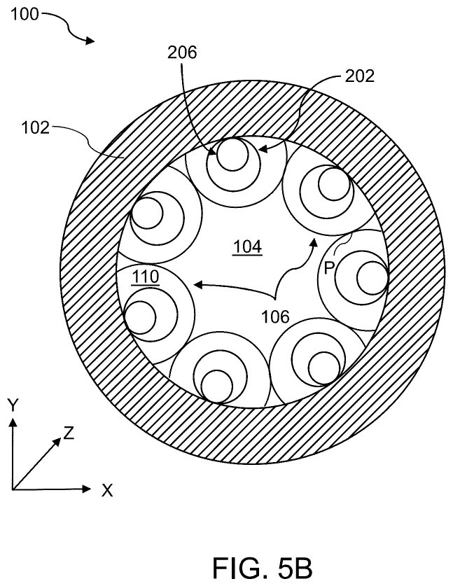

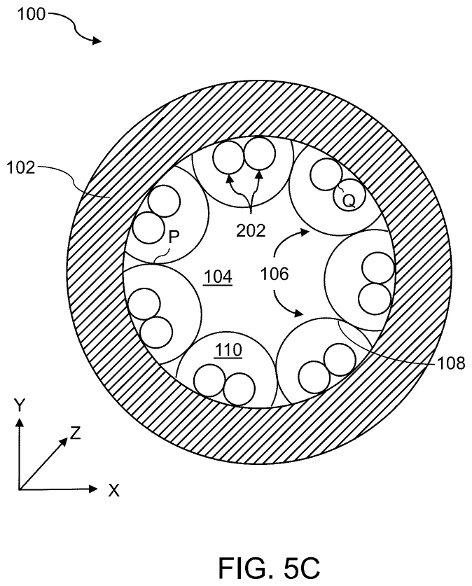

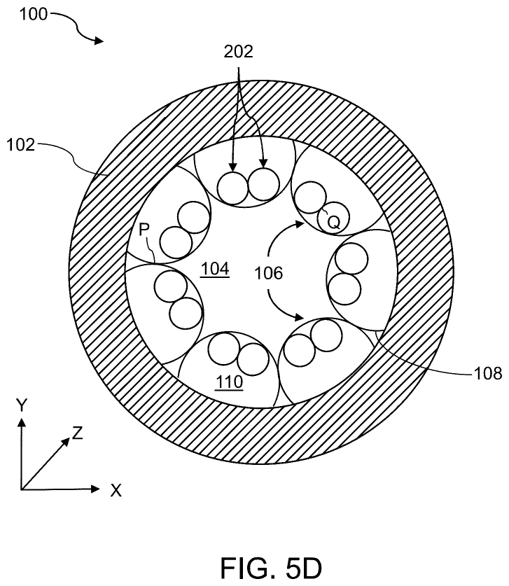

FIG. 5A depicts a cross-sectional view of a twenty-sixth embodiment of the AR-HCF 100, in accordance with one or more embodiments of the present disclosure. The AR-HCF 100 of FIG. 5A is substantially similar to the AR-HCF 100 depicted in FIG. 2A, however in the AR-HCF 100 of FIG. 5A, each AR element 106 may not have a cross-sectional shape of a full circle, but may instead have a cross-sectional shape of a truncated circle or a semi-circle. Similar to the embodiments described above, in the AR-HCF 100 of FIG. 5A as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together).

FIG. 5B depicts a cross-sectional view of a twenty-seventh embodiment of the AR-HCF 100, in accordance with one or more embodiments of the present disclosure. The AR-HCF 100 of FIG. 5B is substantially similar to the AR-HCF 100 depicted in FIGS. 2D and 5A. Specifically, in the AR-HCF 100 of FIG. 5B, each AR element 106 (that may have a cross-sectional shape of a truncated circle or a semi-circle) may include a nested AR element 202, which in turn may have a nested AR element 206. The AR elements 202 and 206 may be located at the cladding structure 102.

Similar to the embodiments described above, in the AR-HCF 100 of FIG. 5B as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together).

FIG. 5C depicts a cross-sectional view of a twenty-eighth embodiment of the AR-HCF 100, in accordance with one or more embodiments of the present disclosure. The AR-HCF 100 of FIG. 5C is substantially similar to the AR-HCF 100 depicted in FIGS. 5A and 2B, however in the AR-HCF 100 of FIG. 5C, the two adjacent “touching” nested AR elements 202 may be connected to the cladding structure 102. Similar to the embodiments described above, in the AR-HCF 100 of FIG. 5C as well, the intersection wall portion “P” (where the adjacent AR elements 106 touch) and the intersection wall portion “Q” (where the adjacent AR elements 202 touch) may be engineered to have the same thickness as the thickness of the rest of the walls of the respective AR elements 106 and AR elements 202 (or any thickness less than the thickness of the sum of the wall thicknesses added together).

FIG. 5D depicts a cross-sectional view of a twenty-ninth embodiment of the AR-HCF 100, in accordance with one or more embodiments of the present disclosure. The AR-HCF 100 of FIG. 5D is substantially similar to the AR-HCF 100 depicted in FIG. 5C, however in the AR-HCF 100 of FIG. 5D, the two adjacent “touching” nested AR elements 202 may be connected to the walls 108 of the AR element 106, as opposed to being connected to the cladding structure 102. Similar to the embodiments described above, in the AR-HCF 100 of FIG. 5D as well, the intersection wall portion “P” (where the adjacent AR elements 106 touch) and the intersection wall portion “Q” (where the adjacent AR elements 202 touch) may be engineered to have the same thickness as the thickness of the rest of the walls of the respective AR elements 106 and AR elements 202 (or any thickness less than the thickness of the sum of the wall thicknesses added together).

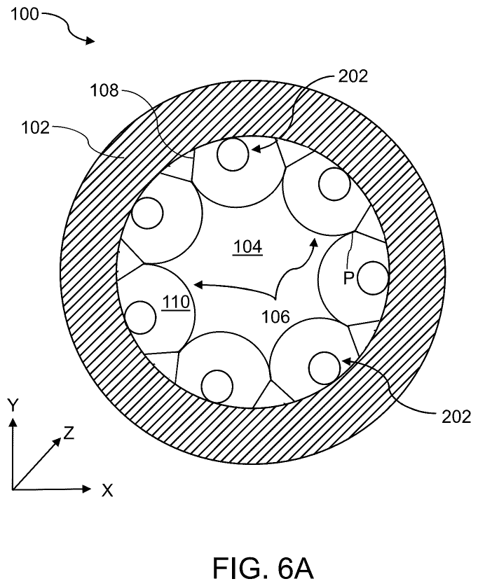

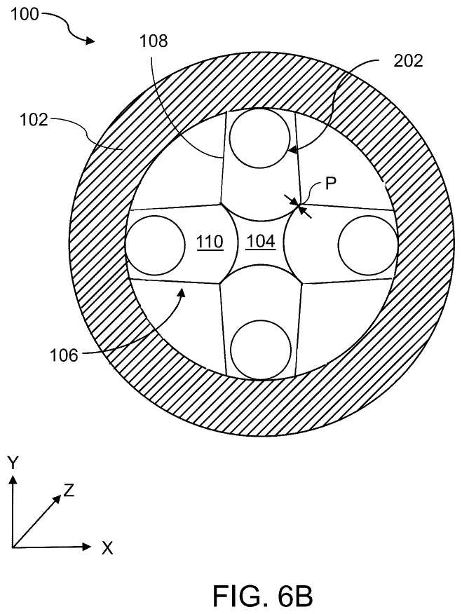

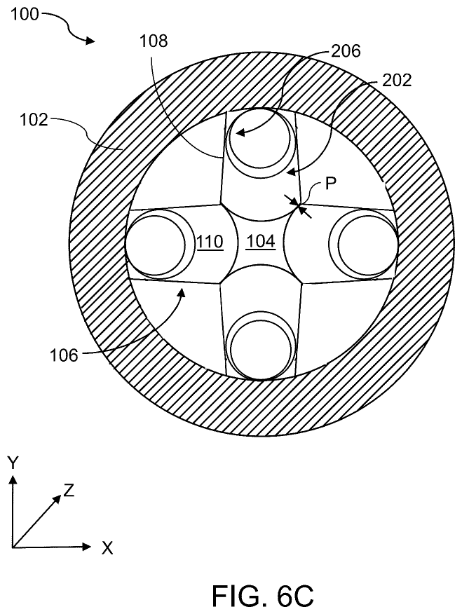

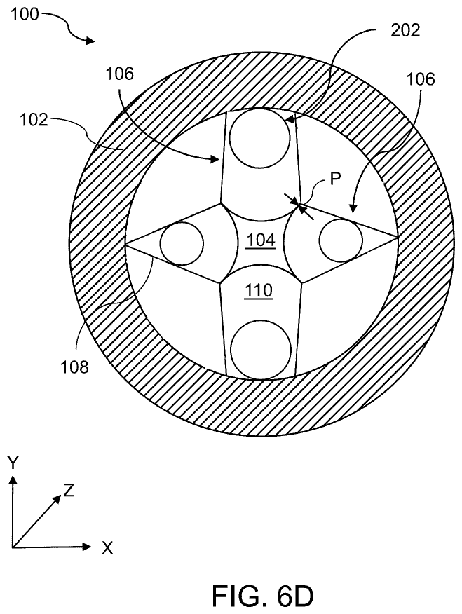

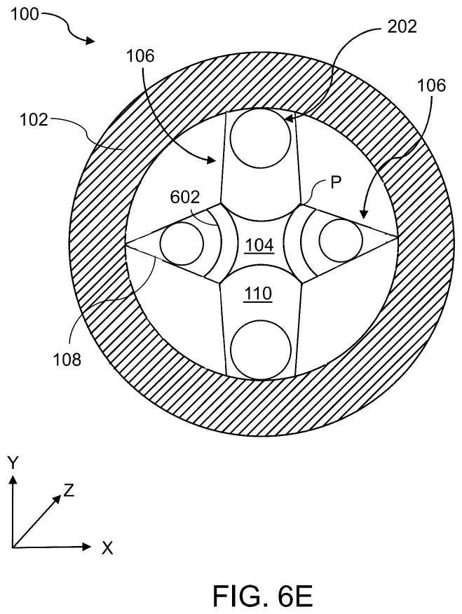

FIG. 6A depicts a cross-sectional view of a thirtieth embodiment of the AR-HCF 100, in accordance with one or more embodiments of the present disclosure. The AR-HCF 100 of FIG. 6A is substantially similar to the AR-HCF 100 depicted in FIG. 5A, however in the AR-HCF 100 of FIG. 6A, the portion of the wall 108 of each AR element 106 that connects the intersection wall portion “P” and the cladding structure 102 may be straight (as opposed to being curved, as shown in FIG. 5A).

Similar to the embodiments described above, in the AR-HCF 100 of FIG. 6A as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together).

FIG. 6B depicts a cross-sectional view of a thirty-first embodiment of the AR-HCF 100, in accordance with one or more embodiments of the present disclosure. The AR-HCF 100 of FIG. 6B is substantially similar to the AR-HCF 100 depicted in FIG. 6A, however the AR-HCF 100 of FIG. 6B may include 4 AR elements 106 (as opposed to 7 AR elements 106 depicted in FIG. 6A). In this case as well, the portion of the wall 108 of each AR element 106 that connects the intersection wall portion “P” and the cladding structure 102 may be straight.

Similar to the embodiments described above, in the AR-HCF 100 of FIG. 6B as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together).

FIG. 6C depicts a cross-sectional view of a thirty-second embodiment of the AR-HCF 100, in accordance with one or more embodiments of the present disclosure. The AR-HCF 100 of FIG. 6C is substantially similar to the AR-HCF 100 depicted in FIG. 6B, however in the AR-HCF 100 of FIG. 6C, each AR element 106 may include a nested AR element 202, which in turn may have a nested AR element 206. The AR elements 202 and 206 may be located at the cladding structure 102. In the exemplary embodiment depicted in FIG. 6C, the walls of the AR elements 202 may touch the “straight” wall portions of the AR elements 106 that connect the intersection wall portion “P” and the cladding structure 102.

Similar to the embodiments described above, in the AR-HCF 100 of FIG. 6C as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together).

FIG. 6D depicts a cross-sectional view of a thirty-third embodiment of the AR-HCF 100, in accordance with one or more embodiments of the present disclosure. The AR-HCF 100 of FIG. 6D is substantially similar to the AR-HCF 100 depicted in FIG. 6B, however in the AR-HCF 100 of FIG. 6D, one or more straight wall portions of the AR element 106 that connect the intersection wall portion “P” and the cladding structure 102 may be at different angles relative to other straight wall portions. For example, as shown in FIG. 6D, one or more straight wall portions may be inclined at greater angles than the other straight wall portions, and may touch each other at the intersection point on the cladding structure 102 (thereby forming a triangular shape). Such an arrangement of the walls 108 may allow different placement of the AR elements 202 closer or farther away from the center of the hollow-core fiber. Further, in this case, the AR element 202 nested in the “triangular-shaped” AR element 106 may have a smaller diameter than the diameter of the AR element 202 nested in other AR elements 106 (which are not triangular shaped).

Similar to the embodiments described above, in the AR-HCF 100 of FIG. 6D as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together).

FIG. 6E depicts a cross-sectional view of a thirty-fourth embodiment of the AR-HCF 100, in accordance with one or more embodiments of the present disclosure. The AR-HCF 100 of FIG. 6E is substantially similar to the AR-HCF 100 depicted in FIG. 6D, however the AR-HCF 100 of FIG. 6E may include one or more additional curved walls 602 that may be present in the interior region 110 of one or more AR elements 106. The curved wall 602 may be similar to the additional wall 402 described above. Although FIG. 6E depicts a single curved wall 602 in each triangular-shaped AR element 106, the present disclosure is not limited to such an embodiment. In additional embodiments, all the AR elements 106 may include the curved walls 602, and/or one or more AR elements 106 may include more than one curved wall.

Similar to the embodiments described above, in the AR-HCF 100 of FIG. 6E as well, the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together). In embodiments, one or more AR elements 202 may be a “snowman.”

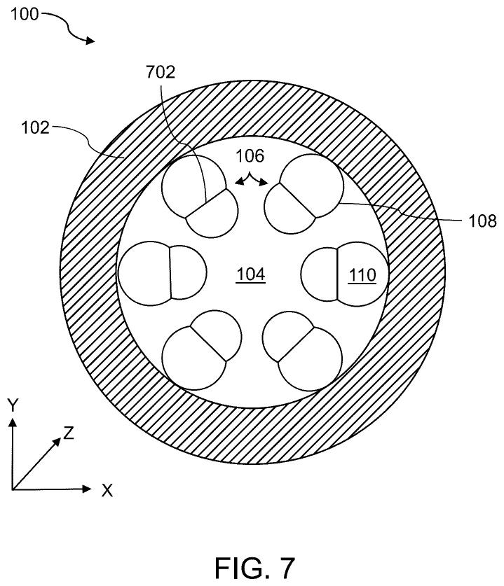

FIG. 7 depicts a cross-sectional view of a thirty-fifth embodiment of the AR-HCF 100, in accordance with one or more embodiments of the present disclosure. The AR-HCF 100 of FIG. 7 includes the AR elements 106 that are shaped as “snowman” (instead of being shaped as a circle or a truncated-circle, as described above). In this case, each AR element 106 may include an additional wall 702, which may be similar to the additional wall 402 described above. Further, one or more snowman-shaped AR elements 106 may touch adjacent AR elements 106, or the snowman-shaped AR elements 106 may not touch adjacent AR elements (as shown in FIG. 7). When the snowman-shaped AR elements 106 touch adjacent AR elements 106, then the intersection wall portion “P” (where the adjacent AR elements 106 touch) may be engineered to have the same thickness as the thickness of the rest of the walls 108 of the AR elements 106 (or any thickness less than the thickness of the sum of the wall thicknesses added together). Furthermore, each snowman-shaped AR element 106 may be located on the cladding structure 102.

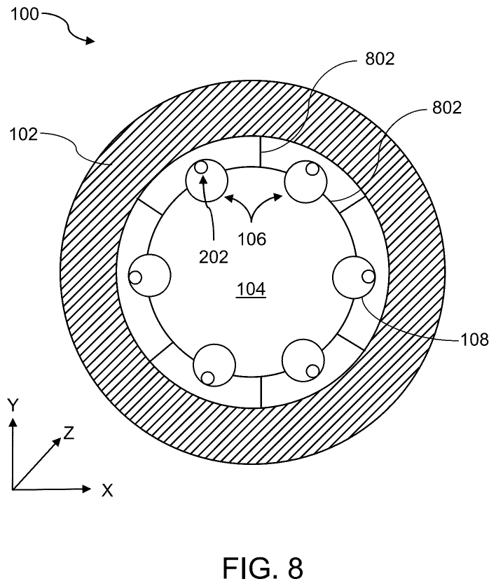

FIG. 8 depicts a cross-sectional view of a thirty-sixth embodiment of the AR-HCF 100, in accordance with one or more embodiments of the present disclosure. In addition to the components described above in conjunction with FIG. 2A, the AR-HCF 100 of FIG. 8 may include a support structure including one or more support walls 802 that may extend from the interior surface of the cladding structure 102. The support walls 802 may be used to position and “hold” the nested AR elements 106, 202 closer to the center portion of the AR-HCF 100 or the core region 104 (and away from the cladding structure 102) where majority of the light propagates. In this case, the AR elements 106, 202 may not be connected to the interior surface of the cladding structure 102, but may rather be connected to the support walls 802 and away from the cladding structure 102 (towards the center portion of the core region 104). Further, in this case, adjacent AR elements 106 may not touch each other, and the intersection wall portion “P” may not exist (and hence engineering of this portion may not be required).

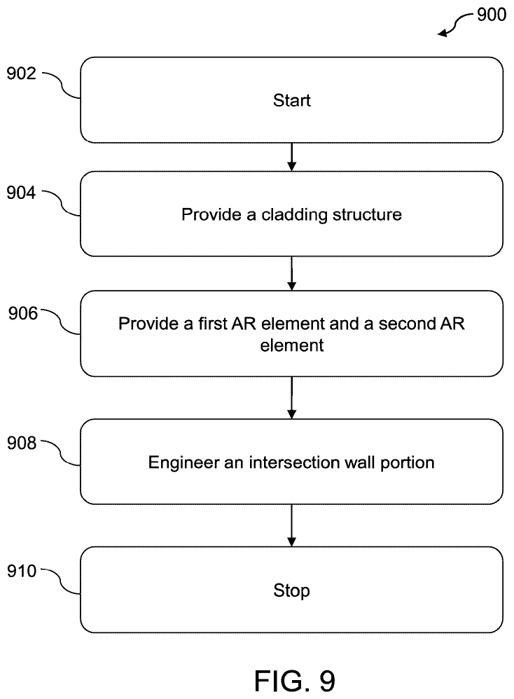

FIG. 9 is a flow diagram of a method 900 to make the AR-HCF 100 in accordance with one or more embodiments of the present disclosure. Applicant notes that the embodiments and enabling technologies described previously herein in the context of the AR-HCF 100 should be interpreted to extend to the method 900. It is further noted, however, that the method 900 is not limited to the architecture/structure/operation of the AR-HCF 100 described above. The steps described in conjunction with the method 900 may be performed by an operator or a controller/processor.

The method 900 may start at step 902. At step 904, the method 900 may include providing the cladding structure 102 that extends along the fiber length providing the core region 104. At step 906, the method 900 may include providing the AR element 106a and the AR element 106b distributed within the core region 104. At step 908, the method 900 may include engineering the intersection wall portion “P” where the AR elements 106a, 106b touch each other, to have an engineered thickness (which may be less than a sum of the wall thicknesses of individual AR elements 106a, 106b, or equivalent to the wall thickness of the AR elements 106a, 106b if their wall thicknesses are equal to each other).

The method 900 may end at step 910.

In other methods the step of engineering the intersection wall portion “P” may occur prior to drawing the fiber. In certain embodiments, a preform may be created using glass (or other material) rods, cylinders, and/or other shapes. Mechanical or other thinning methods (as described herein) may then be used to engineer the material such that in the drawn fiber, the desired intersection wall portion “P” is thinner than the sum of the thicknesses of the touching AR elements. The shape of the drawn fiber structure may be different than the shape of the preform and can be tailored based on fiber-draw parameters, such as draw speed, draw tension, surface tension, draw ratio, temperature, AR-element material, and differential pressures.

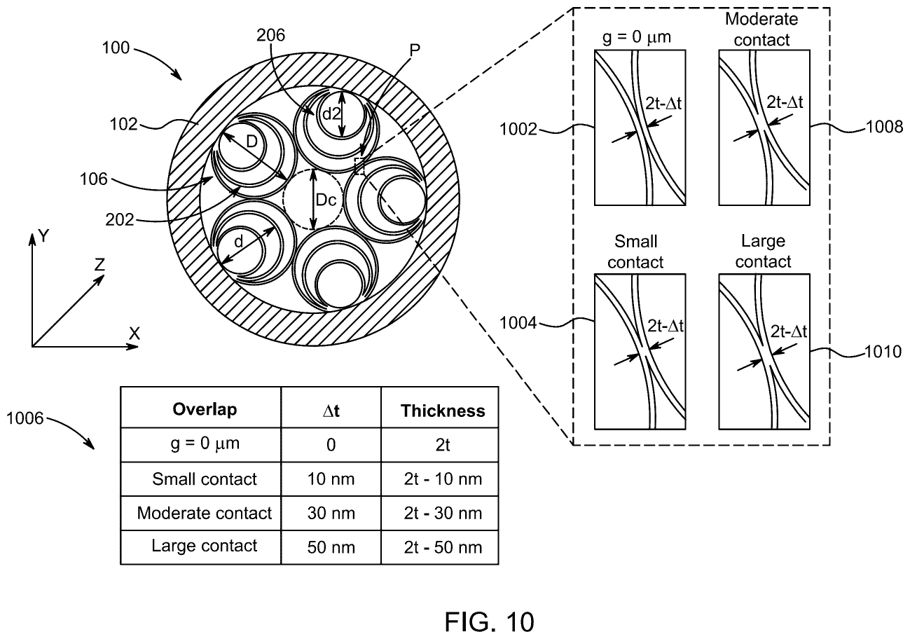

FIG. 10 depicts a cross-sectional view of a thirty-seventh embodiment of the AR-HCF 100, in accordance with one or more embodiments of the present disclosure. The AR-HCF 100 of FIG. 10 is substantially similar to the AR-HCF 100 depicted in FIG. 1J, which has five outer AR elements 106, and each AR element 106 has a nested AR element 202. Further, the nested AR element 202 has another nested AR element 206. In this manner, each AR element 106 may have two nested AR elements 202 and 206 located in the interior region 110 defined by the walls 108 of the AR element 106. The walls of each AR element 106, 202, 206 may have the same thickness (“t”).

In certain embodiments, each AR element 106, 202, 206 may be circular in shape, and the AR element 106 may have an inner diameter “D”, the AR element 202 may have an inner diameter “d”, and the AR element 206 may have an inner diameter “d2”. Further, the diameter of the core of the AR-HCF 100 may be Dc (as shown in FIG. 10). Furthermore, each AR element 106 may touch adjacent AR elements 106 at the intersection wall portion “P” (or node “P”).

As described above, the node “P” is engineered or etched to have a thickness that is less than the sum of the wall thicknesses of the adjacent touching AR elements 106. For example, if the thickness of the walls of each AR element 106 is “t”, the thickness of the node “P” may be 2t-Δt, where Δt is the amount of wall thickness that is etched or reduced during the node engineering process.

Experiments or tests were conducted to measure fundamental mode losses with wavelengths of light propagating through the AR-HCF 100 of FIG. 10, for different extents of overlap “g” between the intersecting walls portions at the node “P”. “g” can be considered as the “overlap” between the two touching walls of the adjacent AR elements 106 at the node “P”. If “g” is 0, it means that the touching walls are just contacting each other with no overlap. If “g” is −10 nm, it means that the overlap is 10 nm (and so on), which is also the same as the value of Δt.

In a first version of the AR-HCF 100 of FIG. 10 that was tested, there was no overlap between the intersecting wall portions at the node “P” (meaning “g” was 0), as shown in an example first view 1002. Consequently, in the first version of the AR-HCF 100, Δt was zero, and therefore the thickness of the node “P” was 2t.

Further, in a second version of the AR-HCF 100 of FIG. 10 that was tested, there was a small overlap (or small contact) between the intersecting wall portions at the node “P”, as shown in an example second view 1004. In an exemplary embodiment, in the second version, Δt was 10 nm, and therefore the thickness of the node “P” was 2t-10 nm, as shown in a table 1006 of FIG. 10.

Furthermore, in a third version of the AR-HCF 100 of FIG. 10 that was tested, there was a moderate overlap (or moderate contact) between the intersecting wall portions at the node “P”, as shown in an example third view 1008. In an exemplary embodiment, in the third version, Δt was 30 nm, and therefore the thickness of the node “P” was 2t-30 nm, as shown in the table 1006.

In addition, in a fourth version of the AR-HCF 100 of FIG. 10 that was tested, there was a large overlap (or large contact) between the intersecting wall portions at the node “P”, as shown in an example fourth view 1010. In an exemplary embodiment, in the fourth version, Δt was 50 nm, and therefore the thickness of the node “P” was 2t-50 nm, as shown in the table 1006.

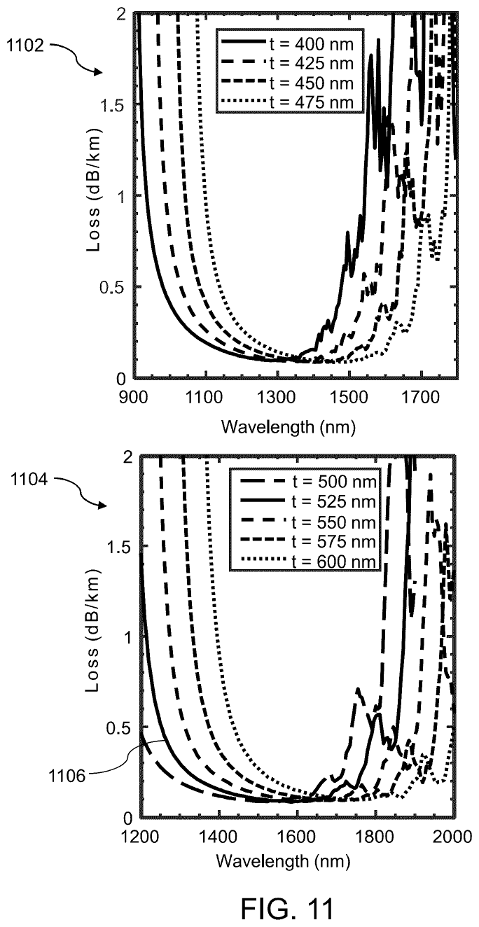

The results of the experiments are depicted in FIGS. 11-20, and described below. The experiments or tests were conducted for an AR-HCF 100 that has the value of Dc as 29 μm, the ratio of (d2/d) as 0.55, and the ratio of (d/D) as 0.8.

FIG. 11 depicts two graphs (a graph 1102 and a graph 1104) that depict fundamental mode losses at different wavelengths (of light propagating through the AR-HCF 100), for different values of “t” (i.e., for different values of wall thicknesses of the AR element 106) and when “g” is equal to zero. Stated another way, the graphs 1102, 1104 depict experimental results for the AR-HCF 100 in which the two touching walls of the adjacent AR elements 106 at the node “P” are just contacting each other with no overlap (and hence Δt =0).

In the graphs 1102 and 1104, X-axis depicts the wavelength of propagating light (in nm) and Y-axis depicts fundamental mode losses (in dB/km). The graphs 1102 and 1104 were generated for the values of “t” equal to 400 nm, 425 nm, 450 nm, 475 nm (as shown in the graph 1102), 500 nm, 525 nm, 550 nm, 575 nm, and 600 nm (as shown in the graph 1104). Based on the experimental results, it was observed that the optimal value of “t” (or the optimal thickness of the walls of the AR element 106) is 525 nm. At this value of “t”, the AR-HCF 100 provides broader transmission window, and lowest transmission loss at a wavelength of 1550 nm, as shown by a graph line 1106. Having lowest transmission loss at a wavelength of 1550 nm is important because in telecommunication application, the center of the “C band” is at 1550 nm. Further, at “t” equal to 525 nm, the AR-HCF 100 provides low transmission loss in the entire S-, C-, L-, U-band (1460-1675 nm).

It is known that the wavelength range of 1530-1565 nm is the main telecom band, which provides lowest attenuation. Optical signals in telecommunication industry are transmitted at this wavelength range, specifically at a wavelength of 1550 nm. Consequently, the value of “t” as 525 nm is considered the optimal thickness (or the “magic thickness”) of the walls of the AR element 106 as the AR-HCF 100 provides lowest transmission loss at the wavelength of 1550 nm at this value of “t”. Furthermore, as described above and shown by the graph line 1106, at this “t”, the AR-HCF 100 provides low fundamental mode losses over a broader transmission window, and hence has more practical applicability in industrial use.

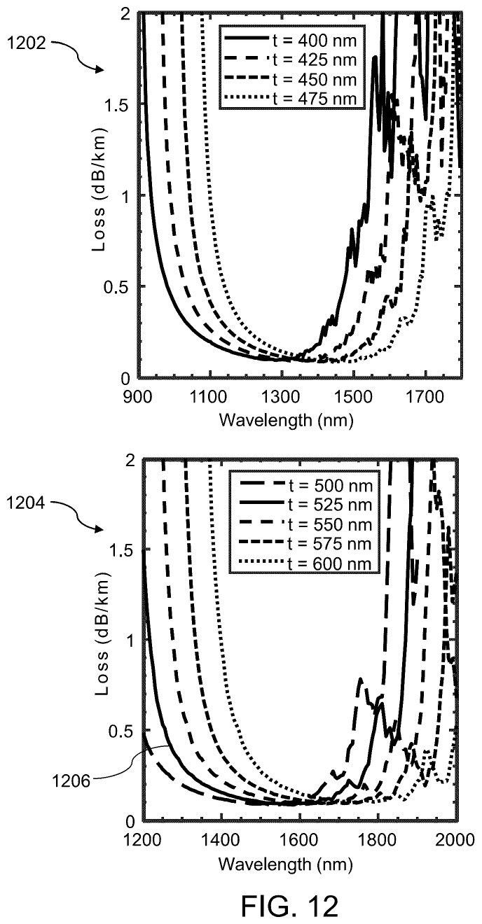

FIG. 12 depicts two graphs (a graph 1202 and a graph 1204) that depict fundamental mode losses at different wavelengths, for different values of “t” and when “g” is equal to −10 nm (or Δt=10 nm). Stated another way, the graphs 1202, 1204 depict experimental results for the AR-HCF 100 in which there is a small contact (or small overlap) between the two touching walls of the adjacent AR elements 106 at the node “P” (and Δt=10 nm).

Experiments have shown that in the version of AR-HCF 100 at “g” =−10 nm as well, the optimal value of “t” is 525 nm. At the wall thickness of 525 nm, the AR-HCF 100 provides low transmission in the entire S-, C-, L-, U-band, as shown by a graph line 1206. By making “g” =−10 nm, the wavelength bandwidth reduces slightly as compared to the version of AR-HCF 100 at “g” =0 (as apparent from the graph lines 1106 and 1206), however, at “g” =−10 nm, the AR-HCF 100 still covers the full S+C+L+U band.

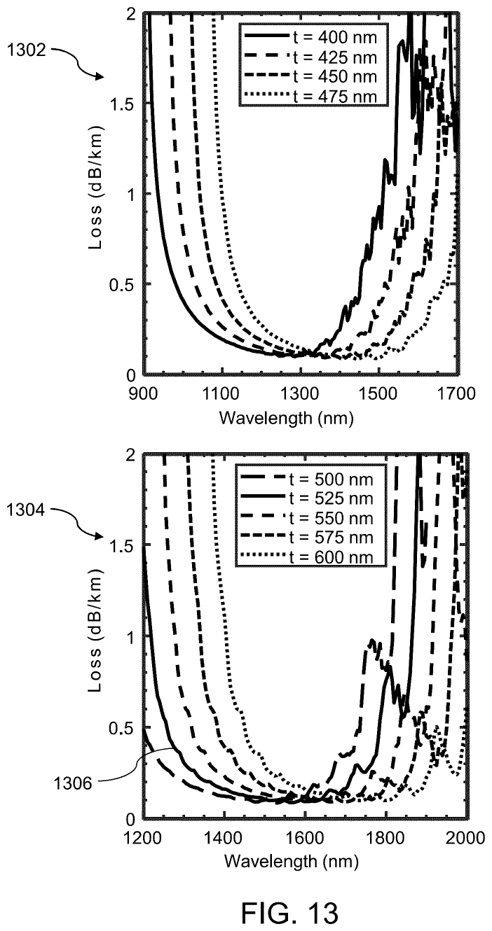

FIG. 13 depicts two graphs (a graph 1302 and a graph 1304) that depict fundamental mode losses at different wavelengths, for different values of “t” and when “g” is equal to −30 nm (or Δt=30 nm). Stated another way, the graphs 1302, 1304 depict experimental results for the AR-HCF 100 in which there is a moderate contact (or moderate overlap) between the two touching walls of the adjacent AR elements 106 at the node “P” (and Δt=30 nm).

Experiments have shown that in the version of AR-HCF 100 at “g” =−30 nm as well, the optimal value of “t” is 525 nm. At the wall thickness of 525 nm, the AR-HCF 100 provides low transmission in the entire S-, C-, L-, U-band, as shown by a graph line 1306. By making “g” =−30 nm, the wavelength bandwidth reduces slightly as compared to the version of AR-HCF 100 at “g” =0 (as apparent from the graph lines 1106 and 1306), however, at “g” =−30 nm, the AR-HCF 100 still covers the full S+C+L+U band.

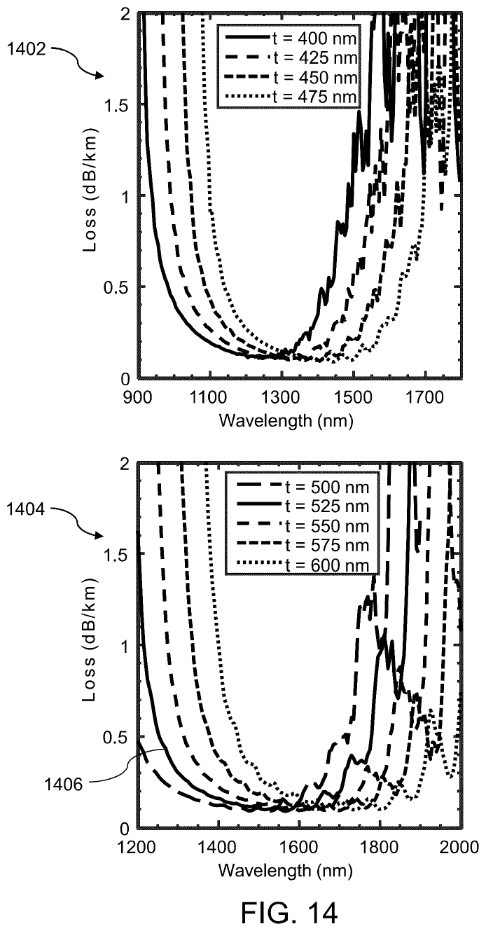

FIG. 14 depicts two graphs (a graph 1402 and a graph 1404) that depict fundamental mode losses at different wavelengths, for different values of “t” and when “g” is equal to −50 nm (or Δt=50 nm). Stated another way, the graphs 1402, 1404 depict experimental results for the AR-HCF 100 in which there is a large contact (or large overlap) between the two touching walls of the adjacent AR elements 106 at the node “P” (and Δt=50 nm).

Experiments have shown that in the version of AR-HCF 100 at “g” =−50 nm as well, the optimal value of “t” is 525 nm. At the wall thickness of 525 nm, the AR-HCF 100 provides low transmission in the entire S-, C-, L-, U-band, as shown by a graph line 1406. By making “g” =−50 nm, the wavelength bandwidth reduces slightly as compared to the version of AR-HCF 100 at “g” =0 (as apparent from the graph lines 1106 and 1406), however, at “g” =−50 nm, the AR-HCF 100 still covers the full S+C+L+U band.

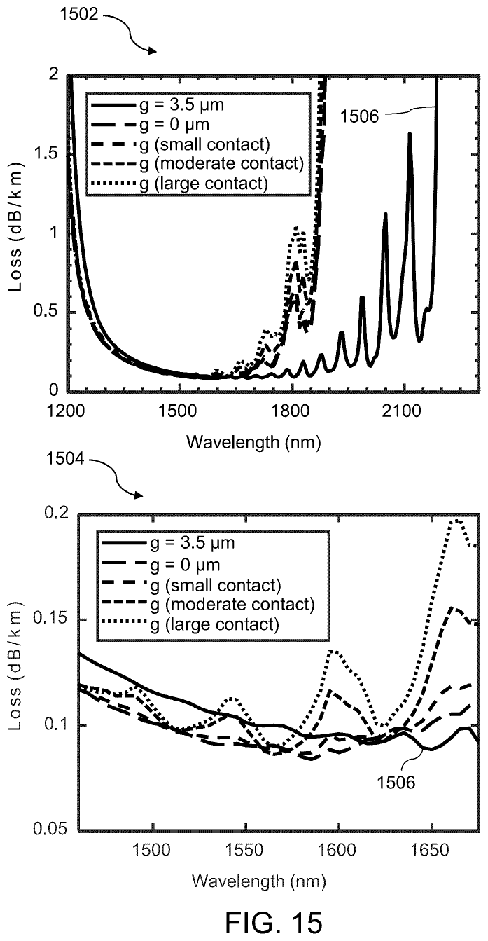

FIG. 15 depicts a first graph 1502 that shows fundamental mode losses at different wavelengths and for different values of “g”, for the AR-HCF 100 having “t” =525 nm. Specifically, the graph 1502 depicts fundamental mode losses at different wavelengths for the AR-HCF 100 having “g” equal to 0, −10 nm (i.e., small contact), −30 nm (i.e., moderate contact), and −50 nm (i.e., large contact). The graph 1502 also depicts fundamental mode losses at different wavelengths for the AR-HCF 100 having a hypothetical “g” of +3.5 μm (i.e., an embodiment where the adjacent AR elements 106 do not touch each other, but are spaced apart by a distance of +3.5 μm). In this embodiment, the ratio of (d2/d) is 0.3 (as opposed to 0.55 in the embodiments described above). FIG. 15 further depicts a second graph 1504 that shows a zoomed-in version of the graph 1502 in the S+C+L+U band.

As apparent from the graph 1502, the version of the AR-HCF 100 in which “g” +3.5 μm provides a broader bandwidth coverage (e.g., covering wavelengths of 1200-2200 nm, as shown by a graph line 1506) as compared to the versions of the AR-HCF 100 that have the value of “g” as zero or negative (i.e., when the walls of the adjacent AR elements 106 touch at the node “P”). However, as apparent from the graph 1504, the versions of the AR-HCF 100 that have the value of “g” as zero or negative have lower fundamental mode losses at the wavelength of 1550 nm, as compared to the version of the AR-HCF 100 with “g” =+3.5 μm. Furthermore, as apparent from the graph 1504, the versions of the AR-HCF 100 that have the value of “g” as zero or negative generally have lower fundamental mode losses in S+C+L band (1460-1625 nm), as compared to the version of the AR-HCF 100 with “g” =+3.5 μm. Therefore, the versions of the AR-HCF 100 that have the value of “g” as zero or negative provide better industrial applicability.

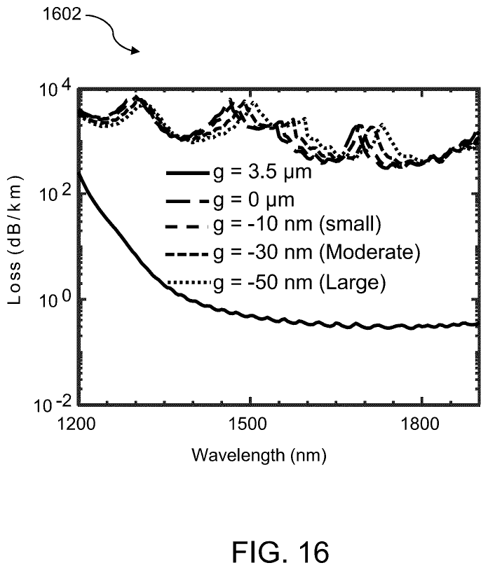

FIG. 16 depicts a graph 1602 that shows higher order mode losses at different wavelengths and for different values of “g”, for the AR-HCF 100 having “t” =525 nm. For example, the graph 1602 depicts higher order mode losses at different wavelengths for the AR-HCF 100 having “g” equal to +3.5 μm, 0, −10 nm (i.e., small contact), −30 nm (i.e., moderate contact), and −50 nm (i.e., large contact).

It is known that when light is transmitted through the hollow core of an AR-HCF, higher order modes of light transmission are formed, which are undesirable because they cause dispersion, mode instability, and interference with single-mode performance. During light transmission, it is preferred that only the fundamental mode (LP01) of light transmission should exist, and the higher order modes should be suppressed or attenuated. Stated another way, it is desirable that loses in the fundamental mode of light transmission should be as low as possible, and the losses in the higher order modes should be large (to cause them to radiate out into the cladding). A person ordinarily skilled in the art may appreciate that when light travels in the fundamental mode, the electric field is most intense at the center of the core and gradually fades outwards. The light propagates with least dispersion and loss in the fundamental mode. On the other hand, the electric fields in higher order modes exhibit more complex patterns, with multiple lobes or rings of intensity. The light interacts more with the core-cladding boundary in the higher order modes, making the light signals more prone to loss and dispersion. Therefore, it is desirable that the losses in the higher order modes should be large, to suppress/attenuate most (if not all) of the higher order modes.

As apparent from the graph 1602, the losses in the higher order mode are considerably greater (and hence provides better performance) in the versions of the AR-HCF 100 that have the value of “g” as zero or negative, as compared to the version of the AR-HCF 100 with “g” =+3.5 μm.

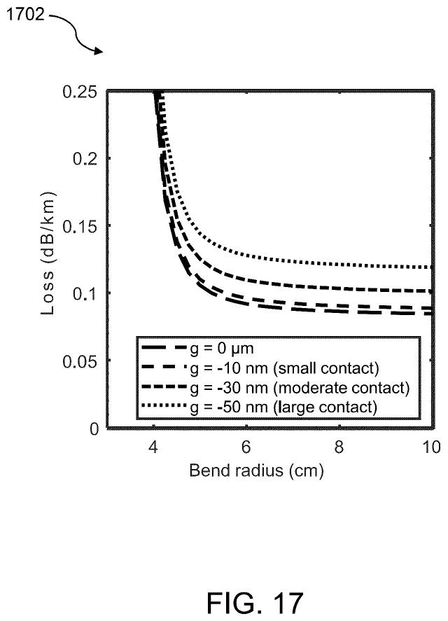

FIG. 17 depicts a graph 1702 that shows fundamental mode losses at different bend radii of AR-HCF, for the AR-HCF 100 having “t” =500 nm. For example, the graph 1702 depicts fundamental mode losses at different bend radii (which is shown in the X-axis) for the AR-HCF 100 having “g” equal to 0, −10 nm (i.e., small contact), −30 nm (i.e., moderate contact), and −50 nm (i.e., large contact). The graph 1702 depicts the impact of fiber bend on the losses.

As apparent from the graph 1702, the AR-HCF 100 exhibits very good bend performance, i.e., the losses are very low when the fiber is bent, especially at “g” equal to 0 and −10 nm. Further, the losses decrease substantially as the bend radius is increased.

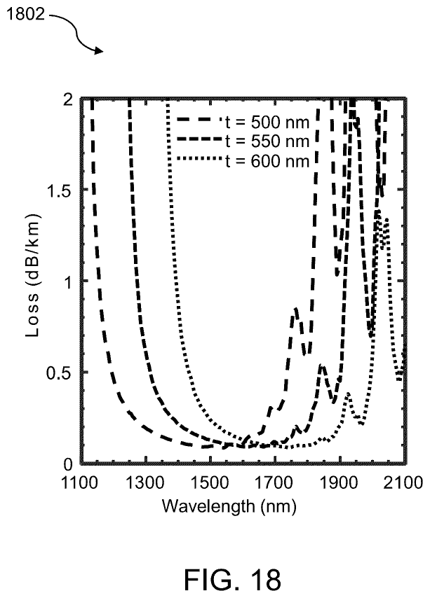

FIGS. 11-17 depict experimental results for the AR-HCF 100 in which the walls of the AR elements 106 (and the AR elements 202, 206) were not doped. Specifically, FIGS. 11-17 depict experimental results for the AR-HCF 100 in which the walls of the AR elements 106, 202, 206 are made of only silica fiber. FIGS. 18-20 depict experimental results for the AR-HCF 100 in which the walls of the AR elements 106 (and the AR elements 202, 206) are F-doped (i.e., doped with Fluorine). It is known that when the walls are F-doped, the refractive index of the walls is reduced. In an exemplary aspect, FIGS. 18-20 depict experimental results for the AR-HCF 100 in which the walls of the AR elements 106, 202, 206 are F-doped such that the refractive index of the walls is reduced by 5×10−3. FIGS. 18-20 are described below.

FIG. 18 depicts a graph 1802 that shows fundamental mode losses for the “doped”AR-HCF 100 at different wavelengths, for different values of “t” and when “g” is equal to zero. The graph 1802 was generated for the values of “t” equal to 500 nm, 550 nm, and 600 nm. It was observed that the performance of the “doped” AR-HCF 100 at “g” equal to zero was similar to the performance of the “un-doped” AR-HCF 100 described above at “g” equal to zero. Stated another way, it was observed that doping that does not significantly affect the performance of the AR-HCF 100 at “g” equal to zero (i.e., the losses do not deviate much by doping the walls with Fluorine).

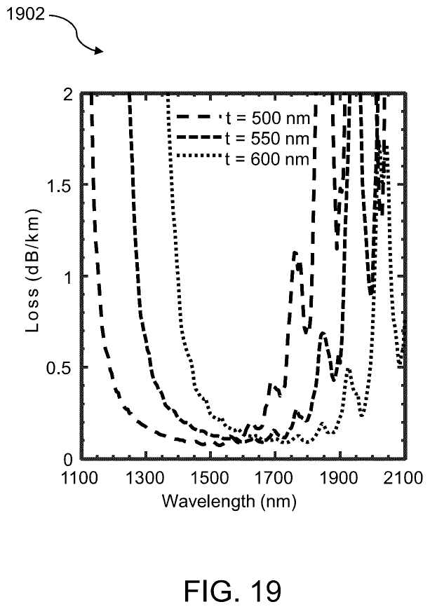

FIG. 19 depicts a graph 1902 that shows fundamental mode losses for the “doped” AR-HCF 100 at different wavelengths, for different values of “t” and when “g” is equal to −10 nm (or Δt=10 nm, or when there is a small contact or overlap between intersecting walls of the AR elements 106). The graph 1902 was generated for the values of “t” equal to 500 nm, 550 nm, and 600 nm. It was observed that the performance of the “doped” AR-HCF 100 at “g” equal to −10 nm was similar to the performance of the “un-doped” AR-HCF 100 described above at “g” equal to −10 nm. Stated another way, it was observed that doping that does not significantly affect the performance of the AR-HCF 100 at “g” equal to −10 nm (i.e., the losses do not deviate much by doping the walls with Fluorine).

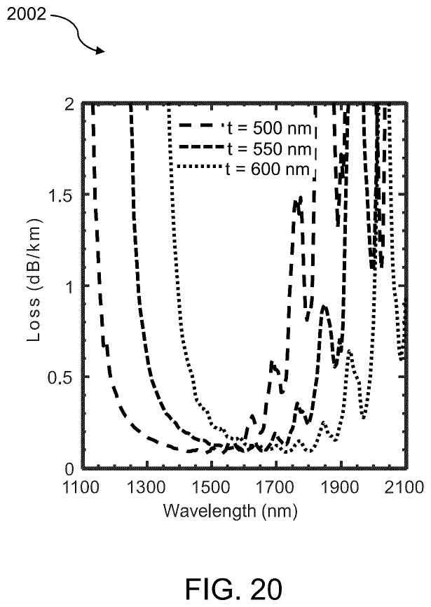

FIG. 20 depicts a graph 2002 that shows fundamental mode losses for the “doped” AR-HCF 100 at different wavelengths, for different values of “t” and when “g” is equal to −50 nm (or Δt=50 nm, or when there is a large contact or overlap between intersecting walls of the AR elements 106). The graph 2002 was generated for the values of “t” equal to 500 nm, 550 nm, and 600 nm. It was observed that the performance of the “doped” AR-HCF 100 at “g” equal to −50 nm was similar to the performance of the “un-doped” AR-HCF 100 described above at “g” equal to −50 nm. Stated another way, it was observed that doping that does not significantly affect the performance of the AR-HCF 100 at “g” equal to −50 nm (i.e., the losses do not deviate much by doping the walls with Fluorine).

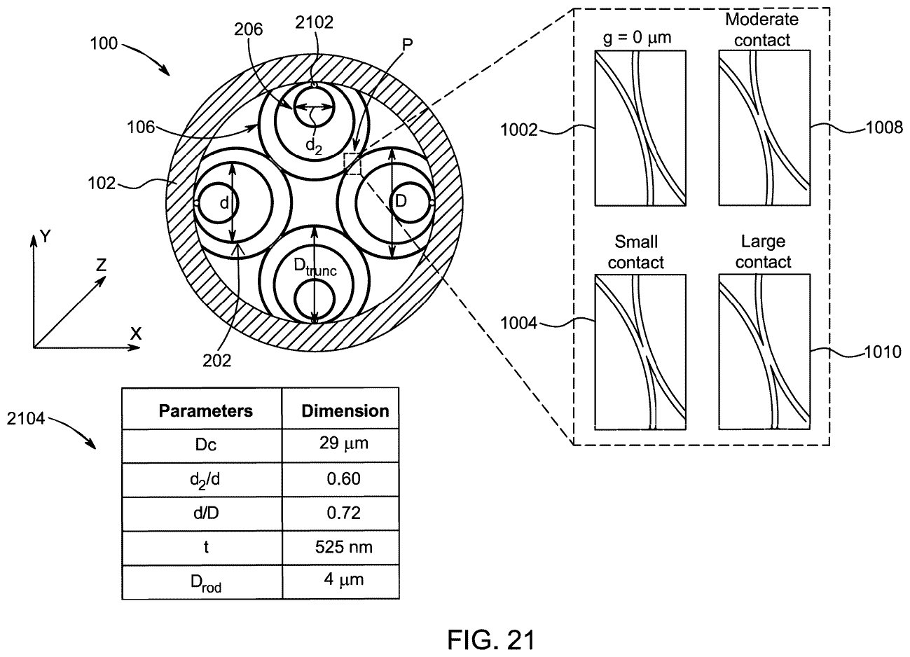

FIG. 21 depicts a cross-sectional view of a thirty-eighth embodiment of the AR-HCF 100, in accordance with one or more embodiments of the present disclosure. The AR-HCF 100 of FIG. 21 is similar to the AR-HCF 100 depicted in FIG. 1G, which has four outer AR elements 106, and each AR element 106 has a nested AR element 202. Further, the nested AR element 202 has another nested AR element 206. In this manner, each AR element 106 may have two nested AR elements 202 and 206 located in the interior region 110 defined by the walls 108 of the AR element 106.

In the AR-HCF 100 of FIG. 21, the AR element 106 may be truncated. Further, in the AR-HCF 100 of FIG. 21, each AR element 206 may be positioned on the interior surface of the cladding structure 102 via a support rod 2102 (which may be similar to the support structure described above). The dimensions of the elements of the AR-HCF 100 of FIG. 21 is shown in a table 2104. Specifically, in the AR-HCF 100 of FIG. 21, the diameter of the core Dc is 29 μm, the ratio (d2/d) is 0.6, the ratio (d/D) is 0.72, the value of “t” is 525 nm, a diameter “D_{rod}” of the support rod 2102 is 3 μm, and a diameter “D_{trunc}” of the truncated part is 61.92 μm.

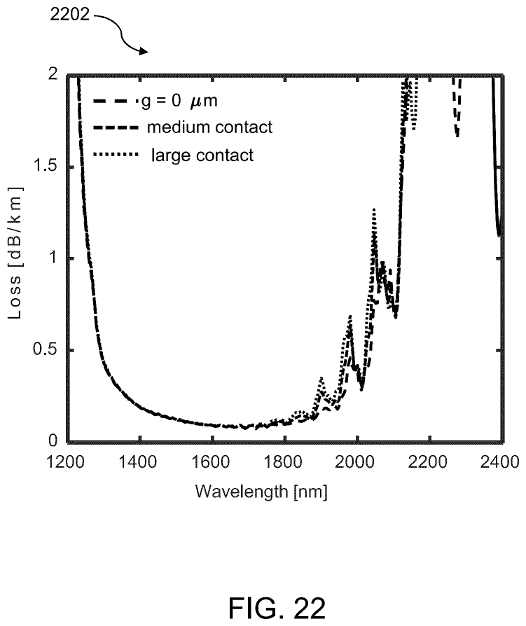

Experiments or tests, similar to the ones described above, were conducted for the AR-HCF 100 of FIG. 21. It was observed in the experiments that the wavelength bandwidth can be increased to 2100 nm in the AR-HCF 100 of FIG. 21, as compared to 1800 nm in the AR-HCF 100 of FIG. 10. Stated another way, it was observed that the AR-HCF 100 of FIG. 21 provides ~300 nm of additional bandwidth as compared to the AR-HCF 100 of FIG. 10. The test results for the AR-HCF 100 of FIG. 21 are depicted in FIGS. 22-24, and described below.

FIG. 22 depicts a graph 2202 between fundamental mode losses and wavelengths for the AR-HCF 100 of FIG. 21 for “g” =0, −30 nm (i.e., medium contact), and −50 nm (i.e., large contact). As apparent from the graph 2202, the wavelength bandwidth increases to 2100 nm in the AR-HCF 100 of FIG. 21. Stated another way, the AR-HCF 100 of FIG. 21 provides relatively low losses at wavelengths up to 2100 nm, thereby significantly enhancing its industrial applicability.

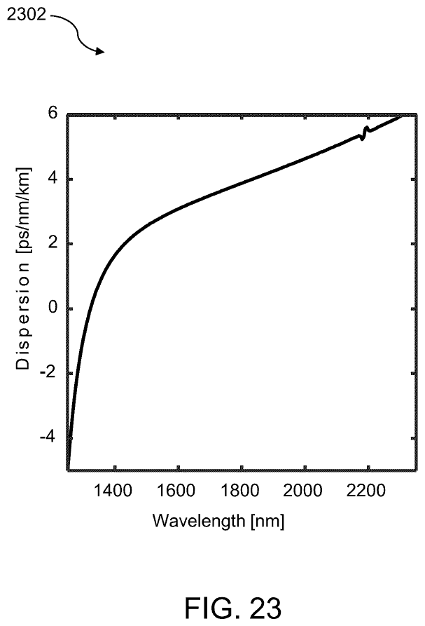

FIG. 23 depicts a graph 2302 between dispersion and wavelengths for the AR-HCF 100 of FIG. 21 for “g” =−30 nm (i.e., medium contact). As apparent from the graph 2302, the AR-HCF 100 of FIG. 21 exhibits low dispersion over a wide wavelength range.

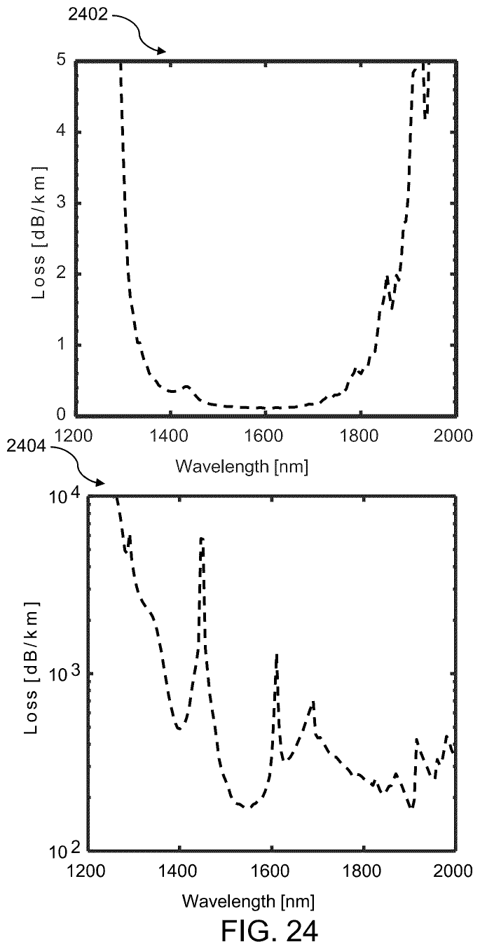

FIG. 24 depicts a first graph 2402 between fundamental mode losses and wavelengths for the AR-HCF 100 of FIG. 21 for “g” =0, and a second graph 2404 between higher order mode losses and wavelengths for the AR-HCF 100 of FIG. 21 for “g” =0. As apparent from the graphs 2402 and 2404, the AR-HCF 100 of FIG. 21 exhibits low fundamental mode losses and high higher order mode losses over a wide wavelength range.

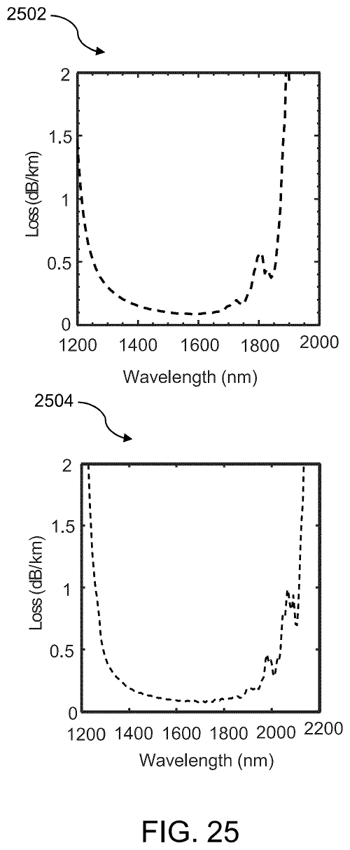

FIG. 25 depicts a first graph 2502 between fundamental mode losses and wavelengths for the AR-HCF 100 of FIG. 10 at “g” =0, and a second graph 2504 between fundamental mode losses and wavelengths for the AR-HCF 100 of FIG. 21 at “g” =0. FIG. 25 is provided for comparison purpose. As apparent from the graphs 2502 and 2504, the AR-HCF 100 of FIG. 21 provides low fundamental losses over a wider range of wavelength, as compared to the AR-HCF 100 of FIG. 10.

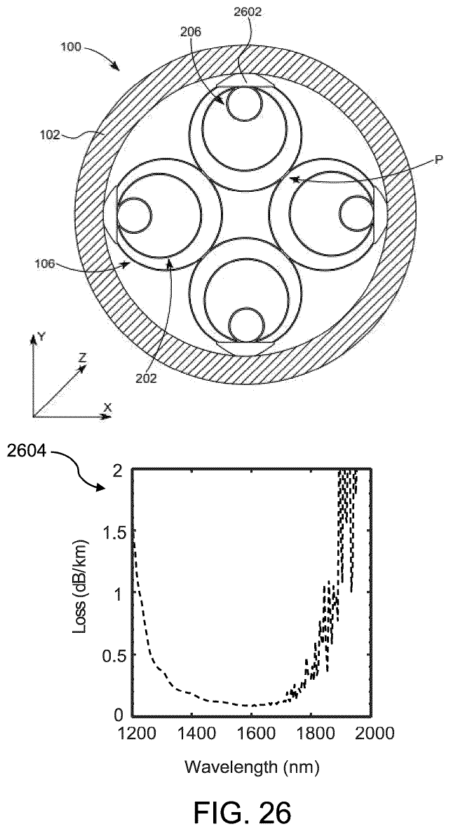

FIG. 26 depicts a cross-sectional view of a thirty-ninth embodiment of the AR-HCF 100, in accordance with one or more embodiments of the present disclosure. The AR-HCF 100 of FIG. 26 is similar to the AR-HCF 100 of FIG. 21; however, in the AR-HCF 100 of FIG. 26, the AR elements 106, 202 and 206 are positioned on the interior surface of the cladding structure 102 via a support structure 2602. In one exemplary aspect, the support structure 2602 may be part of the walls 108 of the AR element 106. The support structure 2602 may be similar to the support structure 302 described above.
FIG. 26 further depicts a graph 2604 between fundamental mode losses and wavelengths for the AR-HCF 100 of FIG. 26 at “g” =0. By comparing the graphs 2502, 2504 and 2604, it becomes apparent that the AR-HCF 100 of FIG. 21 provides slightly better performance and lower fundamental losses over a wider range of wavelength, as compared to the AR-HCF 100 of FIGS. 10 and 26.
Various example aspects directed to an optical fiber are described below.
Aspect 1. An optical fiber comprising: a cladding structure extending along a fiber length providing a hollow interior fiber region; and a first anti-resonant (AR) element and a second AR element distributed within the hollow interior fiber region, wherein: the first AR element and the second AR element are formed as walled structures with one or more walls extending along the fiber length, the first AR element and the second AR element touch each other at a first intersection wall portion, and the first intersection wall portion is engineered to have a first engineered thickness.
Aspect 2. The optical fiber of aspect 1, wherein the first AR element and the second AR element are positioned on an interior surface of the cladding structure.
Aspect 3. The optical fiber of aspect 1, wherein a width or diameter of the first AR element is equivalent to a width or diameter of the second AR element.
Aspect 4. The optical fiber of aspect 1, wherein a width or diameter of the first AR element is different from a width or diameter of the second AR element.
Aspect 5. The optical fiber of aspect 1, further comprising a third AR element located within an interior region of the first AR element bounded at least in part by the walls of the first AR element.
Aspect 6. The optical fiber of aspect 5, further comprising a fourth AR element located within the interior region of the first AR element bounded at least in part by the walls of the first AR element.
Aspect 7. The optical fiber of aspect 6, wherein the fourth AR element is positioned on an interior surface of the cladding structure.
Aspect 8. The optical fiber of aspect 6, wherein the fourth AR element is positioned on the walls of the first AR element and not on an interior surface of the cladding structure.
Aspect 9. The optical fiber of aspect 6, wherein a width or diameter of the third AR element is equivalent to a width or diameter of the fourth AR element.
Aspect 10. The optical fiber of aspect 6, wherein a width or diameter of the third AR element is different from a width or diameter of the fourth AR element.
Aspect 11. The optical fiber of aspect 6, wherein the first AR element further comprises one or more additional walls that divide the interior region of the first AR element into two or more cavities.
Aspect 12. The optical fiber of aspect 11, wherein the third AR element and the fourth AR element are positioned on an additional wall of the one or more additional walls.
Aspect 13. The optical fiber of aspect 6, further comprising a support structure located in the interior region of the first AR element.
Aspect 14. The optical fiber of aspect 13, wherein the support structure has a non-uniform thickness profile.
Aspect 15. The optical fiber of aspect 13, wherein the support structure is positioned on an interior surface of the cladding structure.
Aspect 16. The optical fiber of aspect 13, wherein the third AR element is positioned on the support structure.

In particular embodiments, certain features described herein in the context of separate implementations may also be combined and implemented in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variations of a sub-combination.

While operations may be depicted in the drawings as occurring in a particular order, this should not be understood as requiring that such operations be performed in the particular order shown or in sequential order, or that all operations be performed. Further, the drawings may schematically depict one more example processes or methods in the form of a flow diagram or a sequence diagram. However, other operations that are not depicted may be incorporated in the example processes or methods that are schematically illustrated. For example, one or more additional operations may be performed before, after, simultaneously with, or between any of the illustrated operations. Moreover, one or more operations depicted in a diagram may be repeated, where appropriate. Additionally, operations depicted in a diagram may be performed in any suitable order. Furthermore, although particular components, devices, or systems are described herein as carrying out particular operations, any suitable combination of any suitable components, devices, or systems may be used to carry out any suitable operation or combination of operations. In certain circumstances, multitasking or parallel processing operations may be performed. Moreover, the separation of various system components in the implementations described herein should not be understood as requiring such separation in all implementations, and it should be understood that the described program components and systems may be integrated together in a single software product or packaged into multiple software products.

Various embodiments have been described in connection with the accompanying drawings. However, it should be understood that the figures may not necessarily be drawn to scale. As an example, distances or angles depicted in the figures are illustrative and may not necessarily bear an exact relationship to actual dimensions or layouts of the devices illustrated.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend.

The term “or” as used herein is to be interpreted as an inclusive or meaning any one or any combination, unless expressly indicated otherwise or indicated otherwise by context. Therefore, herein, the expression “A or B” means “A, B, or both A and B.” As another example, herein, “A, B or C” means at least one of the following: A; B; C; A and B; A and C; B and C; A, B and C. An exception to this definition will occur if a combination of elements, devices, steps, or operations is in some way inherently mutually exclusive.

As used herein, words of approximation such as, without limitation, “approximately, “substantially,” or “about” refer to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as having the required characteristics or capabilities of the unmodified feature. In general, but subject to the preceding discussion, a numerical value herein that is modified by a word of approximation such as “approximately” may vary from the stated value by ±0.5%, ±1%, ±2%, ±3%, ±4%, ±5%, ±10%, ±12%, or ±15%. The term “substantially constant” refers to a value that varies by less than a particular amount over any suitable time interval. For example, a value that is substantially constant may vary by less than or equal to 20%, 10%, 1%, 0.5%, or 0.1% over a time interval of approximately 10⁴ s, 10³ s, 10² s, 10 s, 1 s, 100 ms, 10 ms, 1 ms, 100 μs, 10 μs, or 1 μs. The term “substantially constant” may be applied to any suitable value, such as for example, a dimension (e.g., a thickness or diameter), an optical power, a pulse repetition frequency, an electrical current, a wavelength, an optical or electrical frequency, or an optical or electrical phase.

As used herein, the terms “first,” “second,” “third,” etc. may be used as labels for nouns that they precede, and these terms may not necessarily imply a particular ordering (e.g., a particular spatial, temporal, or logical ordering). As an example, a system may be described as determining a “first result” and a “second result,” and the terms “first” and “second” may not necessarily imply that the first result is determined before the second result.

As used herein, the terms “based on” and “based at least in part on” may be used to describe or present one or more factors that affect a determination, and these terms may not exclude additional factors that may affect a determination. A determination may be based solely on those factors which are presented or may be based at least in part on those factors. The phrase “determine A based on B” indicates that B is a factor that affects the determination of A. In some instances, other factors may also contribute to the determination of A. In other instances, A may be determined based solely on B.

Although the foregoing embodiments in the present disclosure have been described in some detail for purposes of clarity of understanding, the invention is not limited to the details provided. There are many alternative ways of implementing the invention. The disclosed embodiments are illustrative and not restrictive.

What is claimed is:

1. An optical fiber comprising:
a cladding structure extending along a fiber length providing a hollow interior fiber region; and
a first anti-resonant (AR) element and a second AR element distributed within the hollow interior fiber region, wherein:
the first AR element and the second AR element are formed as walled structures with one or more walls extending along the fiber length,
the first AR element and the second AR element touch each other at a first intersection wall portion, and
the first intersection wall portion is engineered to have a first engineered thickness.

2. The optical fiber of claim 1, wherein the first AR element and the second AR element are configured to guide light along the fiber length in a core region of the hollow interior fiber region based on optical anti-resonance.

3. The optical fiber of claim 1, wherein the one or more walls of the first AR element have a first thickness and the one or more walls of the second AR element have a second thickness.

4. The optical fiber of claim 3, wherein the first engineered thickness is less than a sum of the first thickness and the second thickness.

5. The optical fiber of claim 3, wherein the first thickness is equivalent to the second thickness, and wherein the first engineered thickness is equivalent to the first thickness or the second thickness.

6. The optical fiber of claim 1, wherein the first intersection wall portion is engineered by using one or more of: mechanical thinning, dry etching, Reactive Ion Etching (RIE), Deep Reactive Ion Etching (DRIE), wet etching, sputter etching, ion beam etching (IBE), or vapor phase etching.

7. The optical fiber of claim 1, further comprising a third AR element located within an interior region of the first AR element bounded at least in part by the walls of the first AR element.

8. The optical fiber of claim 7, wherein the third AR element is positioned on an interior surface of the cladding structure.

9. The optical fiber of claim 7, wherein the third AR element is positioned on the walls of the first AR element and not on an interior surface of the cladding structure.

10. The optical fiber of claim 7, further comprising a fourth AR element located within the interior region of the first AR element bounded at least in part by the walls of the first AR element.

11. The optical fiber of claim 10, wherein the third AR element and the fourth AR element touch each other at a second intersection wall portion, and wherein the second intersection wall portion is engineered to have a second engineered thickness.

12. The optical fiber of claim 11, wherein one or more walls of the third AR element have a third thickness and one or more walls of the fourth AR element have a fourth thickness.

13. The optical fiber of claim 12, wherein the second engineered thickness is less than a sum of the third thickness and the fourth thickness.

14. The optical fiber of claim 12, wherein the third thickness is equivalent to the fourth thickness, and wherein the second engineered thickness is equivalent to the third thickness or the fourth thickness.

15. The optical fiber of claim 7, further comprising a support structure located in the interior region of the first AR element.

16. The optical fiber of claim 15, wherein the support structure is formed as at least a portion of the walls of the first AR element, and wherein the walls of the first AR element have a non-uniform wall thickness profile in a cross-sectional plane defining a shape of the support structure.

17. The optical fiber of claim 1, wherein one or more of the first AR element and the second AR element has a cross-sectional shape as one of: a circle, an ellipse, a truncated circle, a truncated ellipse, a lightbulb, a triangle, a square, a pentagon, a hexagon, a heptagon, or an octagon.

18. The optical fiber of claim 1, further comprising one or more support walls that extend from an interior surface of the cladding structure, wherein the one or more support walls are configured to position the first AR element and the second AR element closer to a center portion of the hollow interior fiber region and away from the cladding structure.

19. An optical fiber comprising:
a cladding structure extending along a fiber length providing a hollow interior fiber region;
a first anti-resonant (AR) element and a second AR element distributed within the hollow interior fiber region, wherein the first AR element and the second AR element are formed as walled structures with one or more walls extending along the fiber length; and
a third AR element and a fourth AR element located within an interior region of the first AR element bounded at least in part by the walls of the first AR element, wherein:
the first AR element and the second AR element touch each other at a first intersection wall portion,
the third AR element and the fourth AR element touch each other at a second intersection wall portion,
the first intersection wall portion is engineered to have a first engineered thickness, and
the second intersection wall portion is engineered to have a second engineered thickness.

20. A method for making an optical fiber comprising:
providing a cladding structure extending along a fiber length providing a hollow interior fiber region;
providing a first anti-resonant (AR) element and a second AR element distributed within the hollow interior fiber region, wherein:
the first AR element and the second AR element are formed as walled structures with one or more walls extending along the fiber length, and
the first AR element and the second AR element touch each other at an intersection wall portion; and
engineering the intersection wall portion to have an engineered thickness.
